(19) United States
(12) Patent Application Publication
(10) Pub. No.: US 2019/0351895 A1
(43) Pub. Date: Nov. 21, 2019

(54) INTEGRATED PROPULSION & STEERING For Battery Electric Vehicles (BEV), Hybrid Electric Vehicles (HEV), Fuel Cell Electric Vehicles (FCEV), AV (Autonomous Vehicles); Electric Trucks, Buses and Semi-Trailers

(71) Applicant: Jacob Ben-Ari, Bat Yam (IL)

(72) Inventor: Jacob Ben-Ari, Bat Yam (IL)

(21) Appl. No.: 16/399,194

(22) Filed: Apr. 30, 2019

(51) Int. Cl. B60W 30/02; B60K 6/387; B60K 6/28; B60W 20/19; B60K 6/26; B60K 6/32; B60L 7/12; B62D 5/04

(52) U.S. Cl. CPC B60W 30/02; F16D 11/00; B60K 6/28; B60W 20/19; B60K 6/26; B60K 6/32; B60L 7/12; B62D 5/0484; B60Y 2200/91; B60Y 2200/92; B60Y 2400/112; B60Y 2400/114; B60Y 2400/202; B60Y 2400/421; B60W 2510/0283; B60K 6/387

(57) ABSTRACT

A vehicle, integrated all-wheel propulsion and steering system with plurality of propulsion and steering power sources, designed with enumerate specifications are coupled to, and de-coupled from a final drive of the vehicle propulsion system. A controller receives input-signals from the driver steering-wheel sensor; computes a set of reactions to the plurality of steering-actuators, wherein feedback-mechanism with each wheel-position sensor, the controller secures each wheel in its computed angle. In different speed and load conditions, the controller is programmed to compute a desired power demand then couple to the final drive[s] the propulsion power source[s] that is designed to do-the-job with the least energy consumption. When the vehicle changes speed and load, the controller couples a different power source[s], and de-couples the previous power source[s] to meet the power demand. In turning-modes, whilst positioning every wheel in its computed position, the controller computes the different distances the left and the right wheels of the vehicle have to travel, wherein the controller moves-up the propulsion power sources velocity to the wheels opposite to the turn to make a perfect turn without EPS assistance.

### BACKGROUND of the INVENTION'S TECHNICAL FIELD

The instant disclosure relates to an all-wheel, digitized integrated electric propulsion and steering configuration for vehicles propelled with electro-mechanical devices or, with electro-mechanical devices in combination with other means of propulsion. Since many billions were spent on AVs R&D emulating human sensing physiology and humans behavior while driving a vehicle; engineers and scientists overlooked the insufficient concerns and funds-dedication to precision propulsion of the wheels and the steering process, which are the actual components that translates the sensing-information—obtained with multiple cameras, ultrasonic sensors, long and short range radars and LiDAR systems—into the vehicle mobility. The disclosure provides the answer to a seamless driving and handling of any EV, autonomous EVs, buses, heavy-duty trucks and semi-trailers by spreading the propulsion and steering task among verity of differently designed, multi-electro-mechanical devices, independently propelling and steering—with merely digitized electronic means—each individual wheel independently while integrating the propulsion and steering system, by emulating animal's four-Pedi motoric.

Level-Five AVs collapses traditional steering value chains by rendering mechanical linkages and steering wheels redundant. Because, there is no common-sense in having sophisticated sensory systems in AVs providing exclusively sensing information of the environment around the vehicle—and then translating this precise information to the wheels, with a 130 years old mechanical-gears technology. The digital, sensory and command tasks performed by the AV's ECUs is unable to communicate with mechanical gears that propel and steer the wheel, yet it easily communicates with all kind of sensors, DC-DC converters, DC-AC inverters, energy-storage units, and all electro-mechanical devices that propel and steer the vehicle's wheels.

Electric Power Steering (EPS) is today a standard fitment across most of vehicles. However, autonomous driving poses several challenges to the steering technology manufacturing community:

First, once a vehicles starts to operate without a driver, steering systems will expect to cater loss-of-assist mitigation in order to provide a safety net as and when the EPS power-pack fails to provide assist for steering the vehicle. This will therefore force steering suppliers to migrate from fail safe systems¹ to fail operational systems for steering. However, the major stumbling block for the steering suppliers is NHTSA [National Highway Transportation and Safety Administration] regulatory compliance, which manufacturer are expecting some modifications to accommodate AVs steering functionality. This disclosure's integrated propulsion and steering concept should be adopted in future technology of choice because:
(i) there is no other effective mechanical solution for AV's steering; and
(ii) it triggers the abolition of EPS and all conventional, mechanical steering gears below the driver's steering-wheel. ¹A fail-safe or fail-secure device is one that, in the event of a specific type of failure, responds in a way that will cause no harm, or at least a minimum of harm, to other devices or to personnel.

In other words: while all wheels are activated with differently computed propulsion power, and all wheels are steered with differently computed steering angles, it is obvious that all-wheel propulsion will take-over the power-steering function of the vehicle; while the integration of the propulsion in the steering process will provide an exceptional stability and maneuverability.

Second, autonomous driving does not require humans to drive the vehicle, in which case the use of steering wheel is made redundant. This then allows OEMs and steering suppliers to concentrate on technologies that will help either eliminate the steering wheel or allow the steering to retract to the dashboard if not required. The bottom line: OEMs realized that steer-by-wire must be the system of choice.

In short; this disclosure attempts to indoctrinate the taboos in mechanical engineering perceptions because, the inventor's philosophy is that vehicles have to be contemplated as an animal and not as a machine. Robots in the industry, should be classified as machines because robots are carrying-out one or at the most very limited, repetitive, pre-programmed functions. Yet a vehicle operates under constant changing driving conditions. Every driving mode is different than the previous one or the next one, which compels to sustain complex multi-objective optimization algorithm to calculate all possible operatives for the next move in milliseconds.

The Philosophy Behind Integrated Propulsion & Steering

The supremacy of mankind materialized about 5,500-years ago with the invention of the wheel, which outperformed evolution since there are no wheels in any known species. Yet, the first most efficient propulsion emerged 5,300-years later when Jun. 12, 1817, Karl von Drais (1785-1851) realized the first self-propelled mobility when he travelled through the streets of Mannheim, Germany with his “Laufmaschine,” the first bicycle. Human muscles create super-efficient propulsion since it is the direct result of close-to-perfection human muscle motoric physiology. The lower part of the brain—with “algorithm” precision activates only the muscles, and their electric degree of intense that is essential to propel the bicycle's pedals; then the pedal motion is transferred to the rear wheel to reach the best efficiency in any given load condition, which is the gist of this disclosure. The nanotechnology in the molecular level—engaging the precise electro-chemical process that excites only the exact number of Actin and Myosin proteins needed to perform precision contraction of the muscle—is not yet worked-out in vitro; but it eventually will become the leading technology in future science because, every bio-technology utilized in lighting, television and a long list of products, makes it many-time-over superior efficient, compared with any other technologies.

The reason the industry needed 130 years to look at a vehicle as an animal, is first because the convenience of cheap fuel, and second, because the dogma taught in engineering schools that only mechanical components in machines are reliable and provide the best alternative to operate a vehicle. The turning point emerged when AV researchers realized the necessity to emulate human physiology ‘perception of the environment’ while driving a vehicle. Yet, the “end-product” of multi-billion-dollar AV-research, translates the ‘environment perception’ into the old, traditional mechanical controlled propulsion and steering, does not make sense.

When visiting Thomas Alva Edison's museum in Fort Myers, Florida man can witness the “old time” philosophy of ‘power transfer’ when one electric motor actuates several ‘consumers’ with one leather belt. In the past—and unfortunately also in the present automobile industry—one crankshaft actuated since 1885 all “consumers” in IC (internal combustion) engines automobiles: the crankshaft rotates the: camshaft with belt or chain, to activate the valve; water pump' oil pump; power-steering pump; alternator; pollution air pump; ignition distributor shaft; AC compressor; transmission and differentials to mechanically synchronize mostly only two wheels.

In system 10 as depict in FIG. 5, 12 electro-mechanical devices—8 for propulsion and 4 for the steering system—contain less than 100 moving parts, while in IC engines the number of moving parts is about 2,000, which explains the 20%-28% efficiency that only reaches the wheels; while over 90% efficiency with electro-mechanical devices. Unfortunately, the current EV manufacturers are continuing the ‘one power source’ doctrine since the majority of EVs are manufactured with only one electro-mechanical device coupled to several mechanical gears to propel only two wheels; and independently, a mechanical steering systems, steers only the front wheels with the traditional electric power-steering (EPS). Heavy-duty and semi-truck's drivers have to steer a 58′ long articulated vehicle with only two steerable wheels in the very front, and the rest 16-wheels of the vehicle are literally dragged behind like a giant monster with dead, out-of-control body. This is definitely not the insight of the future EV business. The bad-news is that many million-jobs in the industry will become redundant, for the “moving-parts” that won't be manufactured.

The first philosophy behind this disclosure is the notion that propulsion and steering complement each other, which seems to be the only way to perform any perfect and stable mobility. Traditional automobile engineering, and new EVs, are constructed with propulsion and steering with no coordination between the two systems. It is obvious that propelling the wheels with one system and steering the same wheels with another is an imperfect arrangement, especially when it is carried out by mechanical means. FIG. 1 presents two separate systems—at the top the vehicle propulsion, and at the bottom is an electric power-steering (EPS),—that differentiate in their assignment, but then with lack of integration between them. This set-up is utilized in 99% of manufactured vehicles, where the IC engine propels only two wheels independent from the driver who steers only the front wheels with different electro-chemical assisted system [EPS].

The second concept is to centralize and digitize-control of all components by exclusively electronic means for precision integration of the propulsion into the steering process; providing AVs the ability to precisely translate the perception of the environment around the vehicle into digitized vehicle propulsion & steering.

The third perception is to split power between multiple electro-mechanical devices to follow the steps of evolution where thousands of muscle-fibers are involved in certain motoric procedure, but a super-efficient precision is arrived at when the brain (controller, ECU in vehicles) elects only those muscle fibers [e.g. electro-mechanical devices] that are sufficient to do the job. Therefore, coupling, de-coupling and precision rotation of plurality of relatively small electro-mechanical devices while steering four wheels, is the ultimate approach to achieve optimization of efficient propulsion and steering mobility.

The fourth philosophy is that one electro-mechanical device can do limited undertaking. Add another electro-mechanical device for different task, sensors, and further relationship becomes possible. Yet, gradually adding more, differently designed electro-mechanical devices constructed to different specifications and different assignment-tasks, with individual, electronically controlled coupling and de-coupling clutches, then the number of complex inter-relationships grows exponentially. FIG. 2 shows a desired healthy balance between integration and differentiation. The theory of healthy integrated systems is when systems complete each other, which contributes to an incomparable vehicle handling and stability that could not be achieved when the systems are not integrated. However, the electro-mechanical devices that are integrated in the propulsion system, and the electro-mechanical devices in the steering system are fully differentiated.

The fifth philosophy teaches us that complex systems accommodating large number of elements that operate in coordination with one another, flinches new mode of actions. This disclosure exhibits relatively simple form of coordination between propulsion and steering, which results from interaction of multiple aggregates in non-linear behaviour. Complexity of multiple-component in non-linear system could never be predicted from just computing a single component and adding it up. Human precision complex motoric is typically acquired during very young age and becomes programmed in the lower brain with association to the cortex. Later on, most motoric undertakings are performed subconsciously through interactions of millions of neurons. The same “specific learned motoric sequence” in humans—with reliance on GPS's memorized road topography and location—may be programmed in the EV controller to accomplish specific turns and down- and up-hill maneuvers with improved efficiency. For example, when the EV faces a down-hill road, and after certain distance it changes to up-hill; with the GPS memory, the controller can calculate the best velocity down-hill to take the up-hill portion easy and efficiently. The same procedure relates to complex turns to be steered efficiently.

The sixth concept is to move into digitized controls and to throw-away the obsolete traditional mechanical gears in propulsion and steering systems. This will result in drastic reduction in weight, in manufacturing cost, and at the same time boost efficiency, precision maneuverability and safety, which will extend the vehicle driving-range, reduce components wear; and, perfectly accommodate any AV's engineering demands to translate the data collected by cameras, radars and LiDAR into a perfect propulsion & steering mobility.

The seventh concept is to completely electrify the trucking industry and pave the road to autonomous heavy-duty trucks and semi-trailers. There is a wide consensus that—concomitant to the enormous transition in the electrification of the light-duty vehicles—the trucking and buses industry has to be revolutionized as well. Diesel engines in trucks, semi-trucks and buses are to become obsolete for the extensive pollution of NOₓ and CO₂ emission and respiratory health detriments. The damage to the environment and the expenditure of health-care will always exceed by far the unsupported claims of the trucking industry that manufacturing and operating electric semi-trailer is much more expensive than diesel. Unsupported arguments as presented infra with supported calculations.

Traditional Mechanical Gears are Obsolete in EVs

This disclosure is obviously not following the steps of engineering schools which support the notion that “bigger is always better.” As a matter of fact, up to last decade, automobile industry only rated vehicles by how fast they go from 0 to 60 mph; totally ignoring efficiency and pollution while neglecting the rest 99.9999% of time traveled. It makes no technological, economical or environmental sense to continuously operate an EV with a single or dual, 175 to 200 HP electro-mechanical device[s] when this level of power is needed only for the first few seconds of propulsion, and in acceleration modes that last only seconds.

It took IC engine engineers about 100-years to register that the classic 350 CID (5,735 cc) Chevy engine could be downsized to 122 CID (2,000 cc), and while equipped with turbo charging system (2018 Camaro), which is only engaged for intervals of seconds at start and in accelerating modes—could produce the same pep as a V8, 350 CID engines, thus pollutes 300% less, and consumes one third fuel.

Today, most vigorous R&D is in artificial intelligence (AI) technologies, which is nothing but a computer science that emulates human's perception of their environment; at the same time that vehicles with IC engines are still equipped with Electronic Control-Systems (ECUs) developed in the 1980s, for the convenience of cheap fuel, indicating that the automotive industry was too long in the technological ‘stone age.’

The Assessment of Battery-Pack Size, Weight and Cost

To follow government regulations to meet CAFE (Corporate Average Fuel Economy) requirements, automakers specific intent is to electrify by 2025 their vehicle portfolios. FIGS. 3 and 4 provides a list of 17 leading manufacturers, introducing 21 EVs in the 2017-19 model years. The two tables specify electric motor[s] HP, efficiency rating in Kilometers traveled per kWh consumption, battery-pack in kWh capacity, traveled range in Kilometers on single charge, curb weight of the vehicle; and, FIG. 3 last column is the efficiency, rated as the ration between the traveled distance in Km and the battery-pack size in kWh. FIG. 4 is a similar table yet, the last column efficiency-rating is the specific efficiency of the propulsion-motor[s] by multiplying the distance traveled by the curb-weight of the vehicle, then dividing by the battery-pack kWh capacity.

At first glance into FIGS. 3 and 4 reveals that the diversity of electro-mechanical devices utilized; and the variety sizes of energy storage-units deduces that manufacturers are not certain about the direction the EV industry is heading. FIG. 3, also presents a distinct distribution of relatively efficient EVs at the top of the list, going stepwise down towards relatively inefficient EVs with electro-mechanical devices exceeding 200 HP. EVs No. 3, 4 and 5 utilize the same 66 HP [49 kW] electro-mechanical device, and have small 14 to 16 kWh size battery-pack, with which the EVs traveled almost eight Kilometers consuming only one kWh; and 100-Kilometers on a single charge. Yet, the three vehicles are relatively very sluggish since they need in average 15 seconds to travel from zero to 60 mph. The last column; the ratio: distant traveled to battery-pack size reveals a distinct discovery. The first 10-EVs have an average efficiency ratings of 9.34 while the last 11 to 20 EVs average at 5.31. The average weight of the first 10-EVs is 1,019 Kg; and the average weight of the second 10-EVs is 1,938 Kg, almost twice. It appears that about 1,500 Kg [3,300 Lb.] is the breaking point in passenger cars efficiency.

A different approach to EVs manufacturing is presented in FIG. 3 by EVs No. 16, 17, 18 and 20. EVs 16-18 are equipped with very large motors and 100 kWh battery-packs. EV No. 16 with 100 kWh uses almost seven-times larger battery-pack than the one utilized in EVs No. 3, 4 and 5. However, EVs No. 16-18 accomplishes an efficiency of about 50% vis a vis EVs No. 3, 4 and 5. The proximate conclusion: adding kWh to battery-packs, and increasing the power-train HP will extend the distance traveled; increase the pep, but at the same time it also increases the vehicle weight, the manufacturing cost, and dramatically reduce the overall efficiency. On the other hand;

The right column in FIG. 4 evaluates the efficiency of the electric motor[s] in physical terms of work to move an object [the EV] that weigh ‘X’ Kilograms from point A to point B, e.g. Range, then divided by kWh consumed. The most surprising results are FIG. 3's EVs No. 16-18 and 20, which are rated in FIG. 4 with efficiency of 12,039 to 11,473, and take places No. 4-6 and 9, although the EVs weight between 2,514 and 2,246 Kg; and carry 5-6 times larger motors than EVs No. 1-3.

23% better efficiency results than Tesla's semi was arrived at with the semi equipped with the subject disclosure, and for enumerate reasons:
(i) Tesla's semi utilizes the same conventional steering as diesel semi-truck, which attributes to 22% of the inefficiencies. Integrating the propulsion in the steering process, and steering also the trailer's two rear-axles will improve efficiency by about 15%; and
(ii) Distributing 10-electro-mechanical propulsion devices along the tractor and the trailer; and de-coupling less then all electro-mechanical propulsion devices will improve the efficiency by about 15-20% on the low side.

In most cases, the decision how to design a vehicle does not begin in the engineering department. The decision is made in the new vehicle showroom by sale personal, providing the information what sells. New-car customers are not interested in efficiency; only the look, the pep and the price of the car usually makes a sale. To meet buyers' demands, several manufacturers listed in FIG. 3 increased the battery-pack kWh and/or the power-train HP from the 2017 to the 2019 models. However, manufacturers No. 3, 4 and 5 in FIG. 3 are still manufacture the 2019 models with the same 15-kWh battery-packs and 66 HP motors as in the 2017 models for the reason of low manufacturing cost and the European market where average daily driving does not exceed 80 Kilometers.

There is huge gulf in opinions about EVs design among manufacturers. Most of them believe that battery technology is the only factor to be improved and the rest of the EV has to be manufactured with the same, traditional die-cutting because, they refuse to accept the fact that EV manufacturing is eventually going to evolve as merely a computer with wheels. The EV chassis and body will be produced by robots, and the few ‘other’ electro-mechanical devices and digital computers—which are not traditional vehicles manufacturing doctrine—will be manufactured by subcontractor. When this stage evolves, it will be indicating the start of revolution in vehicle manufacturing, with the main concern—how to deal with the huge unemployment the EV era will generate.

The size of the battery-pack; the contribution to the vehicle weight and the contribution to manufacturing cost—and how the subject disclosure will contribute in reducing the size of battery-packs, and at the same time improve efficiency—is the core of this disclosure. A rigorous and thorough analysis considering battery metrics as well as vehicle design's parameters was done to decide how to reduce the weight and the cost of the battery-pack. Since personal vehicles are designed with no weight-limitations, the following battery-pack evaluations is concentrating in semi-trucks—since the size of energy-storage needed is more than 10-times larger than in cars—although the equations presented infra should apply to any EV.

The average payload carried by diesel semi-trucks for commodities from different industries is up to 17,300 Kg. The starting point is the fact that Class 8 semi-trailer has to comply with federal requirements of 36,364 Kg GVW; consisting of (i) tractor-truck 8,600 Kg; (ii) empty trailer 6,200 Kg; (iii) battery pack determined weight; and (iv) the size of the payload. The semi-truck empty weight Wᵥ is about 14,800 Kg. Cummins X-15 engine and transmission weight about 1,750 Kg; and differential gears about 400 Kg. Then, a diesel ‘empty weight’ without gears is about 12,650 Kg. Four-motors in Tesla's semi-truck weight 35 Kg.×4=140 Kg. and four differentials about 200 Kg. Then, the electric semi-trailer empty weight Wᵥ should be considered as: 12,990 Kg. The only variable to determine the payload is the battery-pack weight W_{bp}:

(W_{Load})=Wₜ−(W_{bp}+Wᵥ)=36,364 Kg.−(W_{bp}+12,990 Kg); Eq. 1.0

then:

W_{Load}=23,374 Kg.−W_{bp} Eq. 1.1

when:

W_{bp} is the battery-pack weight; and W_{Load} is the permissible load of 36,364 Kg. Theoretically, the maximum payload is 23,374 Kg., less the battery-pack weight.

E_{P} energy, battery-pack size depends on the energy density in Wh/kg. One of the leading battery used in EVs is Panasonic's 3.2 Volt, Lithium Ion battery: LiFePO₄ model NCR18650B with specific energy density of 243 Wh/kg. Lithium batteries contain much lower energy-density than petrol 12,889 Wh/kg, and hydrogen 39,443 Wh/kg. But, battery-to-wheels efficiency is 85%, which includes battery discharge efficiency of 95% and a drive-train efficiency, e.g. batteries propelling electro-mechanical devices are several times over more efficient than IC engines, with 20-28% power reach the wheels. In hydrogen fuel-cell only 36% reach the wheels. Electric Semi-truck will have to meet certain performance requirements at a reasonable cost of operation in order to be a practical alternative to existing diesel semi-trucks. Based on standard dynamics of motor-vehicles, including light- and heavy-duty vehicles up to semi-trucks; to estimate the energy-pack E_{P} size in kWh, the vehicles have to meets dynamic requirements as presented in Eq. 2.0 infra:

$${E}_{P} = [ ( \frac{1}{2} ρ Cd \cdot A \cdot {v}_{rm s}^{3} + {C}_{rr} \cdot {W}_{T} \cdot g \cdot v \cdot {t}_{f} \cdot g \cdot v \cdot Z ) / {η}_{bw} + \frac{1}{2} {W}_{t} \cdot v \cdot a ( \frac{1}{{η}_{bw}} - {η}_{bw} \cdot {η}_{brk} ) ] ( \frac{D}{v} )$$

### Where:

ρ=density of air (1.2 kg/m³)
Cd=Coefficient of drag (0.23-0.63)
A=frontal area of the vehicle (2.8-7.2 m²)
Cᵣᵣ=coefficient of tires rolling resistance (0.0005-0.01)
g=acceleration due to gravity (9.8 m/s²)
Wᵣ=gross on-road vehicle weight (GVW) maximum 36364 Kg. for semi-trucks
Z=the road gradient (r/100)
r=the percentage road grade
t_{f}=the fraction of time the vehicle spends at a road grade of r %
η_{bw}=battery-to-wheels efficiency 85%, discharge efficiency 95%, drivetrain efficiency 90%
η_{brk}=brakes efficiency 97%
ν=average velocity for trucks (m/s) (mph); (16-21); (36-47)
νᵣₘₛ=root-mean-square of the velocity for trucks (m/s) (mph); (19-24); (43-54); and

$$\frac{D}{v} = total time taken for a fixed driving range determined$$

Each of the above parameters is cast as truncated multivariate Gaussian Distribution (truncated within the limits of future projections and known max/min values as depict in FIG. 6, source: Bloomberg BNEF).

Based on distributions of variables, a standard simulation test considering the mean values of an output, the distribution of output values, and the minimum/maximum output values brought the following results:
(i) average annual distance traveled by Class 8 diesel semi-trucks is 75,000 miles. 52-weeks and 6-days a week driving, translates into an average drive of about 250 miles/day, which is accurate statistics for more than 80% semi-trucks travel. Since average semi-trucks speed is about 45 mph, driving 270 miles takes six-hours. Then, battery-pack size, weight, cost, and maximum payload capacity for electric, Class-8 truck is carry out with 480 Km driving ranges, and optional 960-mile range.
(ii) After driving 480 Kilometers, a driver should stop after six-hours; spend 30 minutes charging the batteries to 80% capacity with Mega-charger at 7-cents/kW, and complete the rest 480 Km with another 6 hour drive, which is little above the ‘Federal Motor Carrier Safety Administration Rules’ in which: semi-trailer driver can drive up to 11-hours after being off duty for 10 or more consecutive hours.
(iii) The trucking industry arguments that diesel trucks have a 1,450 Km range in one fueling is not a valid argument because this distance requires 20-hours driving, in violation of federal law. Therefore, the only weight-values considered for the required battery-pack is for 480- and 960-Kms range. For light-duty vehicles, any battery-pack could be utilized—there is no weight limits.

Tesla claims its electric semi-truck achieves 2 miles/kWh. This is probably correct when driving downhills. Tesla's tractor power-train consists of four-192 kW motors and gear assemblies taken from Tesla's model 3. EPA test records confirms that Tesla Model 3 with a single 192 kW motor achieves about 6 Km/kWh with about 1,773 Kg curb weight, and Cd=0.36. Tesla's semi-truck definitively produces much lower than 3.2 Km/kWh results because:
(i) coefficient of drag accounts to 16% of energy loses in Class 8 semi-trucks. Model 3 Cd=0.23 while Tesla's semi-truck has Cd=0.36, which is the result of 57% increase in drag for having frontal area of about 7.2 m², causing an efficiency decrease to about 1.6 Km/kWh in the semi-trailer.
(ii) Tire-drag and rolling-resistance accounts to 22% of energy loses in Class 8 semi-trucks. Assuming a fully loaded semi with 36,364 Kg distributes the weight equally on all 18-wheels, then each wheel carries about 2,000 Kg. Class 8 semi-truck has two steered-tires in the very front and 16 dragged-tires that will massively decrease efficiency by multiple tires rolling-resistance. With a tires rolling resistance coefficient Cᵣᵣ=0.0063, utilizing the SAE J1269 standard test as defined by the Society of Automotive Engineers, the tires rolling resistance of the semi-truck will decrease efficiency to about 1.02 Km/kWh.
(iii) Class 8, diesel semi-truck's engine accounts to 59% of energy loses will not be considered; instead an evaluation how this disclosure will improve electric semi-tucks efficiency is presented infra. All other variables listed in Eq. 2, were not considered because their influence on efficiency is fractional.

Applying the E_{P} energy results to 480- and 960-Km traveled distance; then, fully loaded semi-truck will consumes 470 kWh, and 940 kWh respectively. The W_{P} Battery-Pack Weight calculations are set forth as follows:

$$\begin{matrix} {W}_{P} = \frac{{E}_{P}}{{S}_{P }} where & Eq . 3.0 \\ {W}_{P} = \frac{{E}_{P}}{{S}_{P }} = \frac{470 kWh}{0.243 \frac{kWh}{kg}} = 1 \text{,} 930 Kg for 480 Km range ; \\ and & Eq . 3.1 \\ {W}_{P} = \frac{{E}_{P}}{{S}_{P}} = \frac{940 kWh}{0.243 \frac{kWh}{kg}} = 3 \text{,} 870 kg for 960 Km range , & Eq . 3.2\end{matrix}$$

### Where:

S_{P}=uses the Panasonic's NCR18650B cell with 243 Wh/kg as current.

To calculate limit payload, the above weights are inserted in Eq. 1:

W_{Load}=23,374−1,930˜21,500 Kg, with 470 kWh battery-pack; Eq. 1.1

W_{Load}=23,374−3,870˜19,500 Kg, with 940 kWh battery-pack. Eq. 1.2

Cost_{P}, the battery pack cost: After calculating the battery-pack required energy and weight for Class 8 semi-trailer, the cost is given as follows:

Cost_{P}=E_{P}×Cost_{kWh} Eq. 4.0

The cost of batteries based on several prices available in the market is assumed to have a current mean value of $100/kWh.

Cost_{P}=470 kWh×$100=$47,000 for 480 Km range; and Eq. 4.1

Cost_{P}=940 kWh×$100=$94,000 for 960 Km range. Eq. 4.2

For beyond current Li-ion batteries, it is assumed to be at mean cost of $80/kWh with a minimum value of $50/kWh (see Bloomberg's BNEF estimate in FIG. 6).

Silicon is leading in battery research for two peerless advantages:
(i) It is the third most common element after hydrogen and oxygen; and
(ii) crystalline silicon anode has a theoretical specific capacity of 3,600 mAh/g; approximately ten times that of graphite anodes (372 mAh/g) in Li-ion batteries. Future Silicon Nano-Technology [to overcome swelling and rupturing problems] with 700 Wh/kg and up to 1.0 kWh/kg or better specific density might be available that could reduce the battery-pack energy E_{P} to 470 kWh and 940 kWh respectively; reduce the battery-pack weight to 470 Kg, and 940 Kg, respectively; and the cost to $470 and $970 respectively.
(iii) Magnesium could also become a viable alternative to overcome the safety and energy density limitations faced by current lithium-ion technologies.
   Past experience teaches us that in 1967, the first digital wrist-watch, model CEH-1020 was introduced with a retail price of several hundred US dollars. Today, better digital watches are selling in dollar stores. This is the prognosis for the battery manufacturing community, and in the EV manufacturing turf in particular. The vehicle chassis will be exclusively manufactured by robots; the electro-mechanical devices; DC-DC converters, and the DC to AC inverters will be produced in many millions that will slash the EV's prices to the level of the early 1980s. As a matter of fact; in some vehicle categories, today's EV prices are already lower than the current price of vehicles with IC engines.

### Social-Economic Considerations

To make useful sense of this disclosure, the future social-economic considerations were scrutinized before drafting the disclosure since automobiles in particular, are devices of culture and behavior, not just economics. Both culture and behavior can change quickly for the following reasons:
(i) Because automobile personal ownership is a very bad investment since it is in use less than 10% of the time; automobile ownership is expected to decline dramatically also because the world population is moving into cities, leading to enhancement of car-sharing programs. A car shared by 5-10 people will be running 5-10 times more and less vehicles will be produced. In addition to focusing on reduction in the price of battery manufacturing, and reducing the kW/Kg ratio, to extend the driving range, manufacturers should develop EVs that can withstand the rigors of near-constant driving and have much longer driving range on a single charge.
(ii) Shared vehicles will reduce the desire for personal “options” which usually makes 20-30% of new vehicles price. Another decline in price is expected in the manufacturing of energy storage devices which makes about 30% of the vehicle retail price today. Eventually, the future, average EV retail prices is expected to stretch from below $20,000 to about $30,000. This excludes several manufacturers who retail EVs for a lot more than $40,000, and their sales depend heavily on $7,500 Federal Tax Credit, state and local incentives; and on selling CAFE credits to other manufacturers. Those benefits are expected to be no longer available in the future.
(iii) Before purchasing a new car, the first consideration—which includes lending institutions' top concern—is the projected resale value after 3, 4 or 5 years of the loan. Empirical tests prove that fast-charging procedures—which is expected to be the MO—will shorten battery life. Since the battery-pack makes-up 30% of a new EV price; after 3, 4 or 5 years, when the batteries must be replaced, it will be more than 75% of the entire used vehicle value. Consequently, new vehicles with large battery-packs would have zero resale value as use-vehicle.
(iv) When the EV industry reaches production of 20-30 million BEVs/year, soaring demand for Lithium, Cobalt, Nickel and other rare earth metals such as: neodymium magnet Nd₂Fe₁₄B, and samarium magnet [cobalt SmCo₅]—with magnetic field exceeding 1.4 Teslas—could be monopolized by China since it controls 90% of the world mining of those elements. The monopoly—especially when China logged 60% of global EV sales [according to Bloomberg]—will skyrocket prices to levels that would lead to dis-economy. Minimizing, or totally giving up the use of rare earth magnets is one of the goals of this disclosure.
(v) Dispose of large quantities of battery hazardous waste is another reason to produce efficient EVs with small storage-units or find alternatives in the bio-technology, which demonstrates impressive recycling and efficiency results.

Defeating Electric Motors Inefficiencies & Cost

IC engines waste most of their energy they consume; only 28% in diesel and 20% in gasoline engines get to the wheels. FIG. 7 depicts two representatives of the IC engines family distribution of typical, relatively narrow useful range of torque and power over speed (RPM). Both engines have similar, very narrow peak of about 100 Kw (134 HP) power-output but then, a very different characteristic of torque distribution. If these engines were directly coupled to a drive shaft without a multi-gear transmission, the engine will stall. Large transmissions were constructed to fit within narrow, effective operable RPM of IC engines, and secure enough torque, to provide optimal power to the wheels in changing speed modes.

Most electro-mechanical devices are designed to run at 50% to 100% of rated load; maximum efficiency is usually near 75% of rated load. The specific example of Motor #3 in FIG. 8, with ‘High-Efficiency Range’ between 47 and 73 mph, gradually increases from point a of just below 80% efficiency to just below 90% maximum efficiency level b, which is also the point of ‘break-down torque.’ However, if output-power continues beyond point b, then efficiency will gradually be reduced to 80% when reaching point c and rapidly to lower efficiency thereafter.

Unfortunately, drive-train design in most EVs listed in FIGS. 3 and 4 is inherited from vehicles with IC engines because today's EVs are assembled by manufacturers who assembled IC engine vehicles for decades with design concept of: “one power source does it all.” The single power source is usually paired with a gearbox [most EVs use a single gear transmission], then connected to a mechanical differential that transfers power to the wheels with two or four drive-shafts. Electro-mechanical devices are much smaller, lighter, and have higher HP/Kg ratio than IC engines. Electro-mechanical devices can also be constructed in infinite designs and sizes; an advantage in fitting them in any vehicle's category; and, electro-mechanical devices are the only solution to operate propulsion and steering in AVs.

FIG. 9 is a typical, non-linear energy-consumption vs. speed in current EVs with a single induction-motor. Cruising at 60 mph the EV consumes about 15 kW. Doubling the power to 30 kW brings the EV only to 84 mph; 40 kW to 93 mph; 50 kW to 100.4; and 60 kW reach the speed of 106 mph. Calculations shows that the subject EV travels overall only 1.8 times faster but consumes 4-times more while traveling at 60 mph. Yet, the lower consumption is between 25 and 35 mph.

How far efficiency can go was demonstrated 2009 by VW with the XL-1 concept-car, first presented in the 2013 Geneva automobile show. In addition to its super-aerodynamic (Cd=0.189); its light-weight carbon-fiber reinforced polymer (CFRP) which facilitates only 1,749 Lb. curb weight, and its hybrid propulsion of two pistons, 800 cc diesel engine, producing 50 HP with an electric-motor that adds 27 HP; brings about the impressive efficiency of 280 to 313 mpg, more than twice the average current EVs. In full power mode, the XL-1 can also run 125 mph. The attainment relating to the subject disclosure is by virtue of the fact that cruising in a windless highway at 62 mph (100 km/h) with only 8.3 HP supports the philosophy that most of the time, 175-200 HP electro-mechanical devices are inefficient.

Synchronous motors are rated with better efficiency than induction motors attributable to their permanent magnets in the rotor, while induction motors consume part of the current's energy to create the rotor's magnetic field. Yet, synchronous motors have many “side effects” and high price that diminishes their efficiency issues. Synchronous-motors are very expensive; they overheat, which calls for an extensive water-cooling system, especially with 175 to 200 HP and larger motors. Torque ripple and rotor skew produces annoying vibrations, similar to the annoying vibrations in high compression IC engines. Manufacturing synchronous motors with Neodymium is very expensive, and dependable on monopolized supply, which could lead to dis-economy.

Induction motors are very simple, require no ‘rare-earth-elements,’ are robust, air-cooled, and cost a fraction of synchronous motors. Tesla's best-selling model S is equipped with induction motors. The German magazine “Das Elektroauto & E-Mobilitats-Portal” reports that in March 2019 that the Tesla Model S is sees by “Schwake” [German Blue Book] as a three-year-old with 60,000 kilometers “at a considerable 60% residual value [considering the Model S has an induction-motor] while Porsche Panamera stands at 57.4%.”

In spite of induction-motors' lower-efficiency, power distribution among four-pairs of electro-mechanical devices as depict in system 10 (FIG. 5), eliminates the detriment of induction motors vis a vis synchronous motors, as illustrate in FIG. 10; because, by utilizing optimization algorithm to determine optimal power distribution with the least power consumption among four-pairs of electro-mechanical devices in different speed intervals, establishes much better efficiency than one or two synchronous motors by activating only the electro-mechanical device[s] pairs that are needed, to meet any power demand, all other are de-coupled.

Electro-mechanical devices operate with over 90% efficiency when mechanical losses during transmission of power to the wheels are curtailed, which predicts that EVs are great potential in reducing transportation's energy demand. EVs are likewise envisioned to play a significant role in the future of personal mobility and central role in transformation of energy; especially after car-sharing will become the norm. But to achieve the energy turnaround, BEVs must be much more efficient. FIGS. 7 and 8 depict the obvious difference in operational range of torque and power between IC engines and electro-mechanical devices.

To justify an EV design with single electro-mechanical device, all kind of Intelligent Motor Controller (IMC) in the market, and in the patent application process, claim to have solved efficiency problems in electric motors by utilizing microprocessors to monitor motor load and accordingly match motor torque to motor load—maybe in laboratory testing. The process is reducing or increasing the voltage to the AC terminals and at the same time lowering or elevating the current to bring the motor to operate within ‘High-Efficiency Range.’ Unfortunately, IMC provides limited efficiency improvement for a single electro-mechanical devices because, for substantial part of traveled-time, EVs are operating under low load conditions; and Electro-mechanical devices operate inefficient at low and at high angular speed (RPM). The same problem take place at low power output levels, e.g. below 30% rated load and beyond the point of ‘break-down torque.’ Design and mechanical limitations of electro-mechanical device cannot be resolved merely by electronic means. A sophisticated IMCs designed and equipped with all electronic gadgets could not possibly maintain efficient propulsion with a single electro-mechanical device through all driving modes; in every possible vehicle speed, and load situation.

If emulating human physiology to create AI (artificial intelligence) is so widespread, then why human's and certain mammals' motoric physiology is not considered in manufacturing EVs? FIG. 11 represents the complexity of muscles (motoric apparatus) necessary to create the precision movements in the fastest animals on the planet. The muscles are directly attached to the motoric sites and are only controlled “by [neurons] wires” through feed-back mechanisms, with relatively very small brain (controller); and supported by all kind of sensors. There is no case in evolution where a single muscle “does it all.” Humans' 6,000 years of creative history cannot measure up to 2.5 billion years of selective evolution that extinguished inefficient species and let survive only those with the best coordinated motoric system. In the Cheetah's muscle diagram, it is noticeable that the muscles in the rear Pedi are much more voluminous than the front Pedi, because with the rear Pedi the Cheetah accomplishes more than 80% of the motoric thrust.

FIG. 11 further shows [in solid black] a Cheetah that could reach speeds of over 115 K/h by using both rear Pedi, and front Pedi to achieve a very fast sprint forward. However, the Cheetah's precise operation is different than horse galloping that put into motion one Pedi at a time. A slow-motion video of running Cheetah establishes that both rear Pedi hit the ground at the same time while the front Pedi hit the ground most of the time at the same time. Yet, in maneuvering “modes,” the Cheetah hit the ground with the front Pedi in a very fast sequence, one after the other to steer the body as needed. Turning to the right, the Cheetah hits the ground with the front left Pedi harder to force the turn to the right. Because Cheetahs were “operational” millions years before Karl Benz put the first automobile on the road in 1885, this observation deduces that for much better power distribution and stability, the rear wheels better be equipped with more powerful, but identical electro-mechanical devices on each side; and, since EVs are manufactured with rigid chassis, controller 100 provides uneven distribution of speed to the left and the right wheels to force a turn without EPS.

### The Fundamentals of Multi Electro-Mechanical Propulsion

In principle, the decisive difference between this disclosure and other EV designs is the notion that not all electro-mechanical devices have to be engaged in the propulsion and steering all the time. It took engineers many decades to realize that running power-steering pump all the time is extremely inefficient. Today's norm is EPS that assist steering only when the driver moves the steering-wheel. If all muscles, by humans and animals, would be in motion all the time, when only the legs are used to walk, humans and animals would be sleeping every 2-hours to “charge their batteries.” The concept of this disclosure is a design of a multiple, distinctively designed electro-mechanical devices, participating most of the time only in their highest efficiency range of propulsion as depict in FIG. 10; then, when the vehicle moves into a different speed and load that fits specifications of another[s] electro-mechanical devices, the previous electro-mechanical devices are de-coupled from the propulsion because the electro-mechanical devices that were just engaged are more efficient in the newly elected load and speed.

This intricate mechanism is designed to preserve small portions of battery-pack energy that adds-up, especially when a vehicle is driven for several hours. This additional energy saved by running a vehicle much more efficient, goes a long way.

It was tested and proven many times over that three fundamental factors affect most of the efficiency in vehicles with IC-engine: 12% for the vehicle's aerodynamics; 22% tires rolling-resistance; and 59% for IC-engines inefficiency. Aerodynamics is a vehicle design issue—in particular, but not limited to the frontal area—which is not a part of this disclosure. The 22% tire rolling resistance and tire dragging, as well as inefficiencies of electro-mechanical devices in certain loads and angular velocities will be drastically reduce with the application of this disclosure, which in addition will ease trucking maneuverability and overcome manufacturing cost barrier of semi-trailers. This disclosure will reduce the battery-pack seize, weight and cost; and at the same time increase the payload capacity.

The concept that electro-mechanical devices operate at over 90% efficiency is only partially correct because it only materializes under specific loads and during specific angular speeds as depicted in FIGS. 8, 9 and 10. The vast reduction in vehicle energy consumption is represented in detail infra.

FIG. 12 displays a detailed cross-section configuration of the front right wheel propulsion-assembly in system 10, as displayed in FIG. 5. The basic parts of the disclosure are two electro-mechanical devices 53, 54 with their individual, coupling and de-coupling dog-clutches mechanisms 86a, 87a as displayed in detail in FIGS. [12, 13, 14, 36 and 37], which repeat itself for the other three-wheels. System 10 could be reducing the number of electro-mechanical devices and utilize in the front or the rear axle only two motors instead of four as depicted in FIG. 14 or in FIG. 37 where a motor without dog clutches is active all the time when the vehicle is in motion in combination with electro-mechanical devices with doc-clutches.

The big advantage of electric-motors over IC engines is the ability to design infinite electro-mechanical devices to fit a diversity of specifications. The industry world-wide utilizes almost only electric power; and therefore, IC engines numbers in the industry are fractional because of their narrow torque output, narrow efficiency range, low durability and cost for having multiple moving parts in all directions. IC engines were only manufactured for the extremely low price, and high energy content of gasoline. Yet, the wider range of efficiency in electro-mechanical devices is not enough to operate an EV with a single electro-mechanical device because it cannot operate efficiently without a transmission across the range of zero to 90 mph and under variable loads. Several manufacturers who built EVs with a single motor are introduced in the model years 2019-2020 EVs with 2-motors: Tesla (first Model S came with one motor), VW I.D. BOOMZZ, Audi e-Tron and Jaguar I-Pace, for engineers realized that distributing power among all wheels leads to better efficiency and stability of the automobile. However, the two motors are not equipped with de-coupling mechanism, and therefore they consume energy all the time when the vehicle is in motion, while the subject disclosure engages only these electro-mechanical propulsion devices that will deliver the best efficiency results.

In consideration of the relatively low load consumption during driving in real world environment, most driving-modes after start are not within the optimum efficiency range, especially when a single electro-mechanical device is utilized. The solution must be a distribution of the vehicle's power demand—in different driving mode—between several electro-mechanical devices, designed with different ‘high-efficiency range of operation.’ Controller 100 [in FIG. 5] utilizes multi-objective optimization algorithm to elect and actuate specific electro-mechanical devices to overlap each other's ‘high-efficiency range of operation,’ and to continuously cover zero to 90 mph in the most efficient range, and at the same time meet the vehicle's load and power demands.

Controller 100 may be programmed to start propulsion with all electro-mechanical devices with 100 kW power to accelerate the vehicle from zero to 100 Kph in less than 5 seconds, which solves the problem EVs No. 3, 4 and 5 in FIG. 3 have with acceleration. Yet, in standard driving, a couple of seconds after start, controller 100 may be programmed to de-couple less then all electro-mechanical devices because at that point and time the vehicle gained sufficient kinetic energy, and to proceed efficiently there is no need to continue the engagement of all electro-mechanical devices, which adds-up to 134 HP/100 kW.

De-coupling electro-mechanical devices promotes efficiency, prevents overheating, and components wear-away. 5 to 10 kW electro-motors cost less than 5% of synchronous 130-kW motor with all attachments. The same applies to small DC-DC converters; and DC to AC inverters. The reason for low prices: small electro-motors and small electronics are manufactured in millions as they are used in diversity of technologies.

FIG. 15 represents a chart with 4 traces, which represents the torque and speed vs efficiency for four, differently designed pairs of electro-mechanical devices that overlap each-other to propel system 10 configuration in optimum efficiency from zero to 90 mph. FIG. 15 is a chart that applies to the propulsion aggregates in FIGS. 12 and 13 for operation of electro-mechanical devices 53, 54 and 57, 58, respectively. Each electro-mechanical device, 53 and 54 or 57 and 58—when engaged in the vehicle propulsion—may be serially coupled to a joint shaft 62 via reduction gears 66, 68 [not shown in detail] that propels the front right and the rear right wheels of the vehicle, respectively. The same configuration is at the left side.

Trace 150 in FIG. 15 shows the output torque of electro-mechanical device 53; trace 151 shows the output torque of electro-mechanical device 54; and trace 152 shows the combined torque provided by electro-mechanical devices 53 and 54. Trace 154 shows the combined power output provided by electro-mechanical devices 53 and 54. Trace 152 shows that the speed range over which a single electro-mechanical device can deliver torque is effectively the sum of the torque output of both electro-mechanical devices 53, 54 when the two electro-mechanical devices are propelling a joint shaft, i.e. put in a serially coupled configuration, they will provide an equivalent output as a single electro-mechanical device with the sum of their power, and the sum of their speed, but then, only the average torque of the two electro-mechanical device. Electro-mechanical device 53 [Trace 150] shows maximum speed at 48 mph, and maximum speed of electro-mechanical device 54 [Trace 151] is 84 mph, then the maximum speed of the right front wheel in system 10 [FIG. 5] may be brought up to 132 mph. The actual benefit of this disclosure is the aptitude of controller 100 to promote efficiency by splitting power when only one of the four pairs of electro-mechanical devices is coupled to satisfy power demand, which is unfeasible in EVs with a single or double electro-mechanical device configurations.

It is to be understood, however, that electro-mechanical devices 53, 54 and 57, 58 are not “pairs” although they operate the same joint shaft. Electro-mechanical devices 53, 54 and 57, 58 may be constructed with different design and specification. Electro-mechanical devices 53, 54 and 57, 58 that are on the right side of the vehicle are “paired” with electro-mechanical devices 51, 52 and 55, 56 that are on the left side of the vehicle, respectively. Because electro-mechanical devices pairs may have the same design and specification, they are engaged in propulsion at the same time except in precision turning modes—for example in tight parking conditions—when controller 100 disables one of the wheels, and slowly activates the other three wheels, using the non-operating wheel as pivoting axis.

Controller 100 may elect to de-couple electro-mechanical devices 53, and/or 54—or any other electro-mechanical devices in system 10—when:
(i) their engagement in the propulsion is not necessary at specific point and time; when the vehicle is operating in a speed range that is not in a specific electro-mechanical devices' ‘high-efficiency range;’
(ii) controller 100 may elect to engage alternative electro-mechanical devices with higher or lower torque or power rating to meet the power demand during changing speed, while maintaining efficiency at optimum; and
(iii) During regenerative mode, controller 100 may be configured to couple all or less than all electro-mechanical devices that are not coupled to promote faster deceleration; maximum gain in converting most of the vehicle's kinetic energy into electric energy; supply the bucked voltage to the respective energy storage units 14, 16; and promote efficiency by getting by without, or with light use of electric braking system, which also prevents wear and tear.

In FIG. 12, disks 87a and 87b are permanently attached to a join shaft that rotates whenever the vehicle is in motion. Because the permanently attached disks' 87a, 87b revolution cannot be altered; before the dog-clutches can be coupled, disks 86a, 86b revolution must precisely matched the permanently attached disks 87a, 87b. Relying on Einstein's theory of relativity pertaining space and time, published 1915 with the title: “Zur Elektro-dynamik bewegter Körper” (“On the electro-dynamics of moving bodies”), there is no fixed frame of reference in universe and every moving body relates to every other body in space and time. Yet, when two bodies travel next to each other, at exactly the same speed, relative to each other, they are stationary.

As reliance on Einstein's theory, the actual operative sequence of dog-clutches—coupling and de-coupling of each individual electro-mechanical devices—is illustrated in FIGS. 12, 13, 16 and 17 as follows:
(i) Utilizing multi-objective optimization algorithm, controller 100, may engage electro-mechanical devices 53, 54 if the algorithm provides that electro-mechanical devices 53, 54 kW is the least energy-consuming in specific driving mode, and at the same time meets system 10's power demand.
(ii) Since revolutions of the permanently attached disks 87a, 87b is constantly monitored by speed sensor 88; and, since disk 86a, 86b RPM information is provided to controller 100 via close-loop feedback-mechanism through sensor 88a, 88b; and because electro-mechanical devices 53, 54 is not under load, controller 100 may spin electro-mechanical devices 53, 54 in a fraction of a second to revolutions that matches precisely disk's 87a, 87b revolutions.
(iii) Controller 100 may then actuate the three-solenoid-sets 81a, 81b, triggering a pull-back of locking-latches 83a, 83b, which causes the releases of the dog-clutch's circular gear 84a, 84b.
(iv) The spring between the disk and the electro-mechanical device 85a, 85b, thrusts the already rotating motor-side disk 86a, 86b forward, to couple the disk with the permanently attached disk 87a, 87b while both disks are rotating at precisely the same angular speed. At this point, rotational power is transferred from the specific, coupled electro-mechanical device to the wheel. The two disks are configured with dog-teeth, claws-teeth or any other means of concave indentation and convex projections that fits perfectly tight one into the other when coupled.
(v) At the same time, controller 100 actuates electro-mechanical devices 53, 54 through DC to AC voltage inverters 43, 44, and with appropriate voltage, current and frequency modulation, satisfies torque, power and RPM demand for optimal propulsion in every mode of operation within the integrated AWD and AW-steering of the vehicle.

When dog-clutches have to be de-coupled as presented in FIGS. 16 and 17: controller 100 may actuates solenoid-set 83c, 83d and by means of electro-magnetic force; dog-clutch 86a, 86b neck is then pulled back; coupling spring 85a, 85b, that kept the two disks coupled is compressed, and dog-clutch circular gear 84a, 84b is then locked back with three latch-sets 84a, 84b in de-coupled position.

To overcome the sluggish start as mentioned supra with EVs No. 3, 4 and 5 in FIG. 3; and to have the pep of a sport car, sustaining zero to 60 mph in less than 5 seconds; controller 100 secures adequate torque and power distribution to all four wheels by actuating all four pairs of electro-mechanical device 51, 52, 53, 54, 55, 56, 57 and 58 in FIG. 5, or elect to actuate for just a few seconds less than all electro-mechanical devices to reach a desired speed of about 30-60 mph. Then, controller 100 may de-couple less than all electro-mechanical devices and continue to maintain the vehicle power demand and efficiency with electro-mechanical devices that are designed to meet the efficiency and power demand within a specific speed, and in any specific driving mode as depict in FIGS. 10 and 14. However, if the driver desires to continue accelerating, controller 100 may continue to engage all or less than all electro-mechanical devices to follow the driver's directives. In smooth driving, before the vehicle reaches the speed of about 50 mph, controller 100 may first actuate specific pair of electro-mechanical devices that were designed to operate efficiently within 50 to 70 mph range [motors #3 for example in FIG. 10] or any other combination of electro-mechanical devices to meet the driver's instructive while carrying on with the least energy consumption, and securing vehicle stability. Before the vehicle reaches the speed of about 70 mph, controller 100 may first actuate the electro-mechanical devices pair that have the capability to operate efficiently in the 70 to 90 mph range [motors #4 in FIG. 10], and only then it may disconnect electro-mechanical devices pair that operated in the 50 to 70 mph range [motors #4 in FIG. 10] or elect any other electro-mechanical device combination.

Two systems, as detailed below, are integrated in one another for much better vehicle dynamics, stability, and exceptional handling and efficiency:

Improving Traditional Inefficiencies in Vehicle Dynamics

Two traditional engineering concepts in current EVs are the paramount contribution to vehicles inefficiencies:
(i) the traditional use of transmissions and differentials to transfer power from electro-mechanical device to the wheels; and
(ii) the continuing implementation of 130 years old mechanical steering; and only in the front wheels while the rear wheels are dragged, triggering vehicle instability.

EPA motor vehicle's Federal Test Procedure is a dynamo-meter driving, which is not a real-world driving environment since in the real world, vehicles don't drive only strait forward as on a dynamo-meter. The scenario of mechanical steering inefficiency is unaccounted for in dynamo-meter testing because during turning procedures, on the road, three tires are dragged to different degrees, especially the two rear ones, and especially in short-radii turns. C_{d} [Coefficient of drag] and the vehicle weight are entered in the dynamo-meter's calculations, yet, the consideration that are ignored are four tires side-slip in their contact-patch, the deformation affecting all four tire carcasses caused by cornering shear-stress-forces and rear wheels dragging. The energy lost in mechanical steering affects EVs efficiency the same way it affects IC engine vehicles, which dramatically curtails the driving range; and, wheel dragging diminishes life expectancy of tires.

A layout of a traditional fixed rear-wheel suspension (FIG. 18) contains a multi-link suspension pointing in all possible directions, to constantly provide ideal geometry to respond to all external dragging forces applied during steering modes; to prevent vibrations; skidding and reduce vibrations and noise. FIG. 19 represents the entire rear-suspension assembly that will be obsolete in EVs. Tires rolling resistance is greatly augmented when wheels are dragged, which reduces the power to the wheels by an average of 22%.

Since traditionally only the front wheels are steerable, a traditional layout of front-wheel suspension (FIG. 20) contains no supporting link-bars or stabilizing link-bars because the front wheels are steered 90° [perpendicular] to turning center and are not exposed to dragging-forces like the rear wheels. To reduce inefficiencies during low-speed steering, the ideal situation in low-speed is to position all four wheels 90° degrees to turning center and eliminate tire dragging altogether to realize close to perfect maneuverability. Because this disclosure is propelling and steering all four wheels, FIG. 21 represents a suspension to fit all four wheels—with minor changes between the front and the rear suspensions—since each wheel have to be steered to different angle and propelled with different speed. Therefore, links and stabilizers happen to be obsolete.

The fact that AWD (all-wheel drive) system provides partial solution for better dynamics and road stability improvement was the first choice by EV manufacturers who utilized one electro-mechanical device in the rear axle, and one electro-mechanical devices in the front axle, coupled via differentials to four wheels and are engage in the propulsion at all times the vehicle is in motion. AWD systems that greatly improve vehicle dynamics were manufactured in limited numbers for their economic expense, and massive mechanical components that caused the vehicle to ‘gain weight,’ and the need for bigger engines. However, AWD systems faded away, for being heavy, costly and inefficient.

The next step in improving stability and efficiency in EVs is the incorporation of single electro-mechanical device inside the wheel. Protean Electric in Michigan claims to improve stability and efficiency in EVs by incorporating a single electro-mechanical device inside the wheel, as represented in FIG. 22. In other words, propelling the vehicle with 2- or 4-wheel direct-drive “by wire.” There are several deficiencies that have to be considered:
(i) connecting two or four different electro-mechanical devices, one on each wheel is a good idea. However, after the first few seconds, when sufficient kinetic energy is delivered, electro-mechanical devices cannot be disconnected to keep propulsion within ‘high-efficiency range’ as depict in FIGS. 8 and 9 because there are no decoupling mechanisms available; and
(ii) constructing an EV with only two or four electro-mechanical devices, e.g. one or two pairs of electro-mechanical devices, is not desirable because, FIG. 10 will then display only one or two traces instead of four. This suggests that one pair will have to cover ‘high efficiency range’ of about 90 mph range; two pairs 45 mph range, instead of about 22.5 mph range for each of the four pairs in system 10.
   It is definitely possible to design electro-mechanical devices that will cover relatively efficient about a 45-mph range. Yet, the motor will perform very inefficient in low and high-speed ranges. The motor will also require much larger investment such as: synchronous motor with all attachments and higher maintenance costs; and the motors are attached to the wheels at all times, which is inefficient.

A sophisticated, mechanical AWD architecture manufactured by Audi, a subsidiary of VW, assists the steering to a certain degree. However, this ‘Quattro’ system (FIG. 23) is expensive, is a enumerate-elements piece of equipment, consisting of: control units, sensors and much more. Between transmission and rear differential is a multiple-plate clutch with integrated decoupling mechanism, and numerous gears and bearings. Central controller ‘ESC’ is attached to multiple sensors to accomplish ‘optimum traction and dynamics.’ In turning modes, the wheel selective torque-controller interacts between brakes & AWD control system to assist steering. When AWD is not required, the controller de-couples the rear wheels for better efficiency.

Audi engineered a different version of AWD. It is a hybrid AWD system (FIG. 24). An IC engine drives the front axle—with a transmission bigger than the engine—and the electric part of the AWD system, with an electric motor and a differential, powers the rear axle, thus making it an AWD system. Another electric motor is integrated inside the IC engine; and together with the electric motor in the rear that propels the rear wheels it creates an AWD, while operating in an all-electric mode. In comparing both versions, it is impossible to overlook the fact that the AWD system in the hybrid version is practically identical to the full mechanical one. The electric rear is only engineered to reduce emission during EPA dynamometer low-speed driving test to obtain better MPG Sticker because, typical mechanical AWD vehicles maintain unfavorable emission and MPG ratings, which is most of the time above federal CAFE standards.

The Ultimate Integration of AWD & AW-Steering

The concept of making vehicles turn better by steering all four wheels has inspired engineers for decades. United States Army experimented with all-wheel-steering jeeps during World War II. Currently, BMW's ‘Integral Active Steering’ featured on the 7-Series and 5-Series, Infiniti (in their G and M cars), the 2014 Acura RLX, and Renault (on the Laguna) are the ones that make use of this technology.

FIG. 25 is a 200 years old front steering geometry, designed by Rudolph Ackermann (1764-1834) in 1818. Unfortunately, the same design dominates the automobile industry to this day, including the EVs listed in FIGS. 3 and 4. FIG. 26 is a layout of AW steering, which applies to the subject disclosure. At first glance, the obvious difference in geometry is the much shorter turning radius; about half the length of conventional steering system; which improves maneuverability to a degree that a driver can perform steering tasks in a very narrow lanes, and tight parking spots he could not manage before. Maneuverability improvement is a great helps especially for articulated vehicles. The paramount benefits of electronic AWD and AW steering is a direct result of eliminating wheel dragging to improves vehicle dynamics; and stability, precision in handling and efficiency, without to carry excessive weight and excessive gears as vehicles with mechanical AWD.

In 2014, Infiniti Q50 was the market's first “steer-by-wire” vehicle, meaning there's no mechanical connection between the steering-wheel in your hands and the wheels on the street. “Turning the steering wheel sends just electronic signals to the steering force actuator, which sends data to the electronic control unit, which forwards it to the steering angle actuator, which turns the wheels” [according to Nissan specs information]. Steering response is quicker and more precise than in a mechanical setup. The results are quicker and more precise steering response, keeps vibrations from the road from annoying the driver, and improves the car's active lane control system. Electronic control includes a car's lane control system, which steps in when the driver drifts out of his lane. The system can adjust steering by electronic means instead of mechanical force, which requires less work.

‘Steer by wire’ cuts the vehicle's weight since no mechanical gears are utilized, which boost efficiency; it make it easier and cheaper to produce left- and right-hand drive versions of the car; it's an easy jump to systems that can be used by drivers who are paralyzed or have other handicaps; it reduces maintenance cost, and creates designing AVs a lot easier.

‘Steer by Wire’ option was initially not welcomed by all drivers because:
(i) The additional cost for such system.
(ii) for 130 years, sitting at the steering-wheel stands in a figurative sense also for exercise of power. The driver has his vehicle under control over the steering wheel, and he can tear around in extreme situations. It's about being deprived of obedience of sheet metal to the driver's command. It takes years to get rid of human's control syndromes.
(iii) Subconscious fear that between steering wheel and wheels on the street no solid connection exists, and steering orders are transmitted only by data cables.
   Safety concerns have slowed the adoption of drive-by-wire technologies. Mechanical systems can and do fail, but the conservative regulators—under the influence of insurance company lobbyists—still see them as being more reliable than electronic systems. However, time have changed because the automobile industry is experiencing technological transition never materialized in such a degree since 1885. Manufacturers are foisting autonomous driving technologies, which will eventually eliminate most, if not all mechanical components utilized in today's vehicles. Propulsion and steer “by-wire” is the next step toward that age. In the coming age of self-driving cars, NHTSA would certainly certify AW-steering and AWD ‘by wire’ since in today's advanced technologies, a problem can be electronically detected before it materializes. Hence, AWD propulsion and AW steering “by-wire” should be safer than any mechanical system.

Back to evolution; most living species are controlling their motoric “by wire” (brain-neurons-muscles). Humans are at the top of the list for their muscle control precision (speech, piano and violin playing.) However, motoric “by-wire” was also utilized by very primitive species that no longer exist, including dinosaurs who lived over hundred million years ago and moved their huge bodies with muscles actuated “by wire.” If it was not safe during 2.5 billion years of evolution, species who carry motoric “by-wire” would have disappeared and replaced by species with better systems. It did not materialize, which makes NHTSA's arguments that “by wire” is unsafe without merit; considering steer-by-wire—approved by FAA—is the norm in aviation for decades. A pilot cannot stop in midair to fix his steering.

### BRIEF DESCRIPTION OF THE INVENTION

The instant disclosure relates to an integrated all-wheel electric propulsion and steering, which may be applied to any class of vehicles—with two or more wheels—in infinite configurations. The comprehensive aspects of this disclosure suggest that EV manufacturers should throw-out all mechanical assemblies utilized in traditional automotive engineering; skip the design stage of manufacturing EVs in admixture with IC engines; and design vehicles propelled only with electro-mechanical devices, and with battery-pack or fuel-cells as energy supply.

This disclosure comprises of plurality of electro-mechanical embodiment, sharing a joint shaft in series, which comprises the basic propulsion aggregate that propels each wheel, with or without reduction gear[s], which is connected with or without a drive-shaft directly to each, independently propelled wheel instead of a speed changing transmission and/or a differential assembly. Each electro-mechanical propulsion device may have its own individual DC-DC converter; and may have its own DC to AC inverter. If DC motor is utilized in any section of the design, then no inverter is necessary. To secure precise diverse torque and angular speed among each individual electro-mechanical device that is active, the controller may actuate all or less than all electro-mechanical devices to reach fast response from stop position to the desired propulsion speed. After gaining sufficient kinetic energy, the controller may de-couple certain motors, and in any given speed and load, actuate the motors that were designed to operate most efficient in that specific speed range and load.

Coupling and decoupling electro-mechanical devices in and out of the vehicle's propulsion process, is carried out by electronic means with an individual dog-clutch for each electro-mechanical propulsion device. If one or more of the propulsion motors are utilized with no dog-clutches—as depict in FIG. 37—then these motors will be running whenever the vehicle is in motion. The intricate electronic coupling and decoupling procedure and sequence of operation of dog-clutches is clarified in detail infra.

Four-wheel steering systems comprises of 4 electro-mechanical devices, where each system is assigned to specific wheel. This small electro-mechanical, wheel-steering device is installed on the vehicle's frame and is connected through a tie-rod and a wheel-position sensor to the knuckle's steering-arm of each wheel. Each wheel-position sensor acts also as a traditional tie-rod-end, and at the same time registers and informs the controller of the actual angular-position of the wheel.

During steering modes, the controller integrates the propulsion into the steering systems by applying different speed to each wheel to perfect the steering process and substitute the power-steering undertaking. Each wheel-position sensor, in any given point and time, sends ‘by wire’ a continuous, precise information about the instant position of each wheel, with which information the controller's data base computes the precise [mostly different] angle and speed for each wheel; and during any speed and load conditions. At the same time, the controller actuates each wheel-steering motor to bring each individual wheel to the precise calculated angle for optimum steering to meet the driver's [or the AV ECU's] set turning angel via the steering-wheel sensor.

A control logic, which may comprise of software, may be stored in the controller's memory as computer-readable memory to receive information from multiple sensors; process information received, and precisely, in conformity with the program stored in the controller, executes a coordinate the integration of propulsion and steering. This logical operation of all four wheels transpires by actuating precise power, torque, speed and proper angle of each wheel—rather than only two wheels in the front or the rear—to accomplish overall traction stability with no wheel dragging, and thus, enhanced maneuverability, safety and optimal efficiency.

This disclosure provides all the safety and stability benefits of mechanical AWD and mechanical AW steering without the “side-effects” of imperfect handling control; poor stability and maneuverability; unnecessary weight; poor efficiency; excessive tire wear; and high manufacturing cost caused by multiple redundant mechanical gears. In addition, with electronic precision control of power, torque, speed and precise position of each wheel, vehicle performance results in catlike (Cheetah-like) handling—resembling a super-efficient model of man-bicycle propulsion efficiency—by consuming the least energy for better efficiency, and at the same time satisfying propulsion demand. This form of precise calculated energy consumption would provide much longer driving range in one charge, and with up to 50% smaller battery pack, 50% off manufacturing cost; and 50% less weight.

Various other features and advantages will be made apparent from the following detailed description and drawings.

### BRIEF DESCRIPTION OF THE DRAWINGS

The drawings illustrate embodiment presently contemplated for carrying out the invention. In the drawings:

FIG. 1 is a set-up of two independent systems—propulsion at the top, and electric power steering (EPS), at the bottom—that differentiate in their assignment. One propels the wheels and the other steers the vehicle with no integration.

FIG. 2 depicts a balanced differentiation and integration in cooperation between propulsion and steering, which contributes to superior vehicle handling and stability compared with conventional, independent propulsion and steering.

FIG. 3 is a list of 17 leading manufacturers, introducing 20 BEVs offered for sale in between the 2017 and 2019 model year. No. 21 is a Tesla semi-truck. No. 22 are specifications of system 10 as described throughout this application; and No. 23 is this application's predicted semi-truck specifications. The listing specifies motor[s] HP/kW, efficiency rating in miles traveled per kWh, battery pack capacity in kWh, traveled range on single charge in Kilometers, and curb weight of the vehicle in Kilograms. The data obtained from this list is methodically analyzed infra.

FIG. 4 is a similar table as FIG. 3; yet, the second efficiency-rating in the last column is specifying the specific efficiency of the electrical motor[s] for the propulsion of the vehicle by multiplying the distance traveled by the curb-weight of the vehicle, then dividing by the battery-pack kWh capacity [consumption].

FIG. 5 is a block diagram of the entire propulsion and steering in system 10, according to one of multi-embodiment designs available in the invention.

FIG. 6 is a schematic of present and future prediction diagram of Tesla's vs. the average market cost of batteries; dollar per kWh.

FIG. 7 is a schematic diagram of the relatively narrow useful range of torque and power over speed (i.e. RPM) in two representatives of the IC engines family; namely, diesel, and gasoline.

FIG. 8 is a diagram of typical three-phase induction-motor displaying a much wider range of torque and efficiency vs speed than IC-engines.

FIG. 9 is a typical schematic diagram of energy consumption in relation to speed in a typical EVs with induction or synchronous-motor, which represents the majority of BEVs listed in FIGS. 3 and 4.

FIG. 10 is a schematic of optimal power distribution with the least power consumption among four-pairs of electro-mechanical devices, which is the crux of this disclosure. Each trace represents the efficiency and torque vs. speed for each pair of electro-mechanical propulsion device. Each pair operates in its specific speed intervals and is replaced by another electro-mechanical propulsion device when the EV speed exceeds its optimal efficiency range of this specific pair. The four-pairs of electro-mechanical devices, overlapping each other's ranges of ‘high-efficiency’ to build a continuous efficient drive from zero to 90 mph, and still meet any speed and power demand.

FIG. 11 is a diagram of a Cheetah with the complexity of multiple muscles [motoric system] necessary to create the Cheetah's four-Pedi precision motoric to establish the fastest animals on the planet. The second depiction is an illustration of the Cheetah's four-Pedi perfect coordination during hunting chase.

FIG. 12 depicts detailed cross-section of the front left and right propulsion aggregates of system 10, which consist of pair of electro-mechanical devices 53, 54, their individual dog-clutches 86a, 86b, the clutches release and pull-back assemblies [see also FIG. 15, 16] with all the accessories.

FIG. 13 is a cross-section of the rear right propulsion aggregate of system 10 as depicted in FIG. 4, which consist of two different electro-mechanical devices 57, 58 with their individual dog-clutches and the clutches release and pull assemblies with all the accessories, which is very similar layout as in FIG. 11 yet with different torque and power configuration.

FIG. 14 is a cross-section of a single electro-mechanical propulsion and steering aggregate representing an alternative for small cars to be utilized in the front or the rear axle instead of two electro-mechanical devices in each wheel.

FIG. 15 is a chart representing torque and power versus speed, which applies to the propulsion aggregates in FIGS. 12 and 12 for operation of electro-mechanical devices 53, 54 and 57, 58, respectively

FIG. 16 depicts a detailed side-view and a cross-section of the dog-clutches release and pull assemblies with all the different electronics, solenoids and hardware involved.

FIG. 17 depicts the motor-side dog-clutch side view, and the permanently attached wheel-side disk with the splines, inside and outside the disks' neck.

FIG. 18 displays a typical layout of rear-wheels suspension supported with multiple reinforcing-links and stabilizing-bars in all possible directions and a rear-wheel differential.

FIG. 19 represents the entire rear-suspension assembly with links and stabilizer-links attached to the vehicle's chassis; and a differential that transfers power to the wheels with two drive-shafts. All these mechanical aggregates will become obsolete in the subject disclosure, as represented in system 10 [FIG. 5].

FIG. 20 is a layout of a traditional mechanical front-wheel suspension in a vehicle with mechanical steering. No reinforcing bars are necessary since the wheels are perpendicular to the turning circle and are not dragged.

FIG. 21 is a prototype suspension to fit all four wheels—with minor changes between the front and the rear suspensions—since each wheel has to be steered, there are no supporting-links, and stabilizing-bars. Noticeable is the wheel-position sensor at the end of the tie-rod connected to the wheel knuckle [not shown].

FIG. 22 represents a system developed by Protean Electric in Michigan, incorporating a single electro-mechanical device inside the wheel, and propelling the vehicle with 2- or 4-wheel direct-drive “by wire.”

FIG. 23 displays a sophisticated, mechanical AWD, manufactured by Audi. Yet, this ‘Quattro’ [AWD] system is expensive, multi-element piece of equipment, consisting of control units, sensors and much more beside the engine, transmission and differentials. The system also assists the steering to a certain degree.

FIG. 24 is Audi's ‘e-Tron Quattro.’ Hybrid AWD system, consisting of an IC engine that drives the front axle, and the electric part of the AWD system, with an electric motor and a differential, powers the rear axle, thus making it an AWD system. Another electric motor is integrated inside the IC engine and together with the electric motor that propels the rear wheels it creates an AWD, operating as all-electric mode.

FIG. 25 displays a 200-years old geometry of front wheels mechanical steering designed 1818 by Rudolph Ackermann (1764-1834) and is unfortunately still dominating the automobile industry, including all EVs listed in FIGS. 3 and 4.

FIG. 26 is a layout of AW-steering as depict in FIG. 5. The obvious difference in geometry is the length of the turning radius in the AW-steering vehicle, which is half the length of a conventional steering system in FIG. 25, providing much smaller turning circle.

FIG. 27 is a layout of a vehicle making a low-speed 90° turn to the right where controller 100 applies precisely calculated higher speeds to the left-side wheels of the EV; and concomitant, activate all four steering electro-mechanical devices, to position each wheel facing the turning center at low speed.

FIG. 28 depicts the preferred design of steering-wheel sensor, emulating mammal physiology with one sensor one nerve configuration. This particular sensor [in system 10] comprises of 60 leaflets, representing 60 different angles the vehicle may turn to. Each leaflet is individually connected by wire directly to controller 100, transmitting by electronic means the desired [by the driver's] turning command.

FIG. 29 depicts different steering-wheel sensor configuration comprising of 60 resistors, connected in series, and representing 60 different angles the vehicle might turn to in system 10. This steering sensor is configured as “add-up” resistance. Controller 100 recognizes a specific angle by the ‘add-up’ resistance in the circuit.

FIG. 30 is a schematic displaying the relation between wheel angle and speed in relation to FIG. 27 where the vehicle makes a 90° to the right. Because the distance to center of turning-circle for both left wheels is much greater [14.6′] than the distance to center of turning-circle for both right-wheels [10′], the left wheels has to travel longer distance—at the same time period as the right wheels—to make a perfect turn.

FIG. 31 is a schematic displaying the relation between the non-linear L/R wheel angle and their respective revolutions. In other words: how many revolutions each wheel has to accomplish to pull off the turn without power steering assistance.

FIG. 32 is an electro-mechanical steering-aggregate, usually utilized in the front wheels. The wheel-position sensor is presented in four different views. A is a central cross-section with the outer tie rod; B is a view from the top of the sensor; C is also a center cross-section but is 90° to the A cross-section; and D is a bottom view of the sensor.

FIG. 33 is an electro-mechanical steering design, usually utilized in the rear wheels. All components are identical to the design in FIG. 32; however, the electro-mechanical device is configured with a rotor that is modified into a nut 118.

FIG. 34 displaces the lack of maneuverability of a traditional, diesel, and the Tesla Class 8 semi-trailer with only two steerable wheels in the front of the tractor, making a 90° right turn at low-speed, which requires 33′ feet lane-width.

FIG. 35 is a single electro-mechanical device [with coupling and de-coupling gears], as utilized in the semi-tractor without the steering system because the two rear-axles in the tractor are practically in the middle of the vehicle, and at any turn, the two rear-axles are pretty much at 90° to turning-center so they don't have to be steered.

FIG. 36 is a different alternative; a combination of two electro-mechanical propulsion devices [with coupling and de-coupling gears] to be utilized in busses, light- and heavy-duty trucks that have only two or three axels and could do with more power combinations.

FIG. 37 is a single electro-mechanical propulsion device without coupling and de-coupling gears because, in specific vehicles, and motor combinations, there might be a design in which a specific electro-mechanical propulsion device is engaged in propulsion at all times. It is usually a more powerful motor.

FIG. 38 displays a suggested design of six electro-mechanical devices for a semi-tractor. They might be designed with the same, or different specifications. Yet, the two rear-axles are not steerable, and the very last electro-mechanical devices pair may be permanent motors that are running all the time whenever the vehicle is in motion, all other four are de-clutchable.

FIG. 39 is a design of four electro-mechanical devices at the rear of the of the semi-trailer with dog-clutches to be disconnected to save energy whenever their contribution to propulsion is not required. All 4-wheels may be steerable.

FIG. 40 depicts a remarkable reduction in the outer radii when the trailer's rear axles are steerable. Optimal setting is when the tandems center in the trailer is following exactly the curve as the center front tractor axle (dotted line).

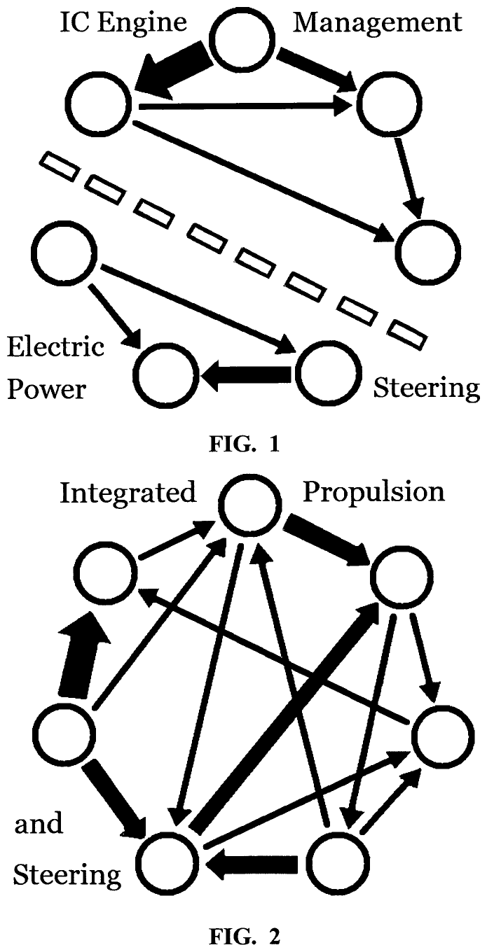

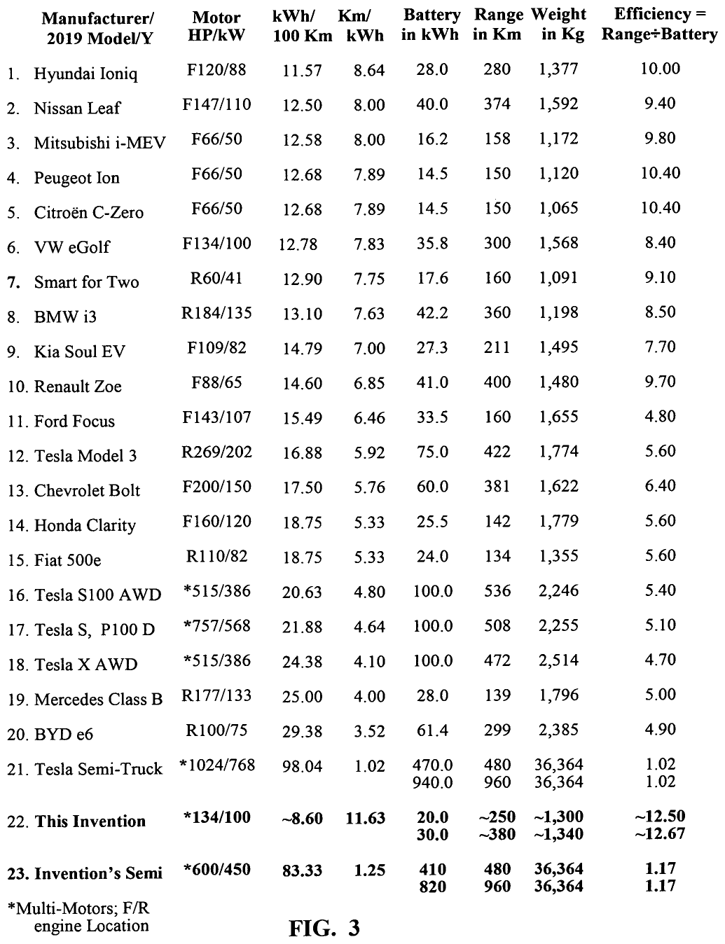

Various other features and advantages will be made apparent from the following detailed description and drawings.

### DETAILED DESCRIPTION OF THE INVENTION

The embodiments of the present disclosure are described herein. It is to be understood, however, that the disclosure embodiment can take various and alternative forms. The figures are not necessarily to scale; some features could be exaggerated or minimized to show details of particular component[s]. Therefore, specific structural and functional details disclosed herein are not to be interpreted as limiting, but merely as variously employ the present invention. As those of ordinary skill in the art will understand, various features illustrated and described with reference to any one of the figures can be combined with features illustrated in one or more other figures to produce embodiment that are not explicitly illustrated or described. Various combinations and modifications of the features consistent with the teachings of this disclosure, however, could be desired for particular application or implementation.

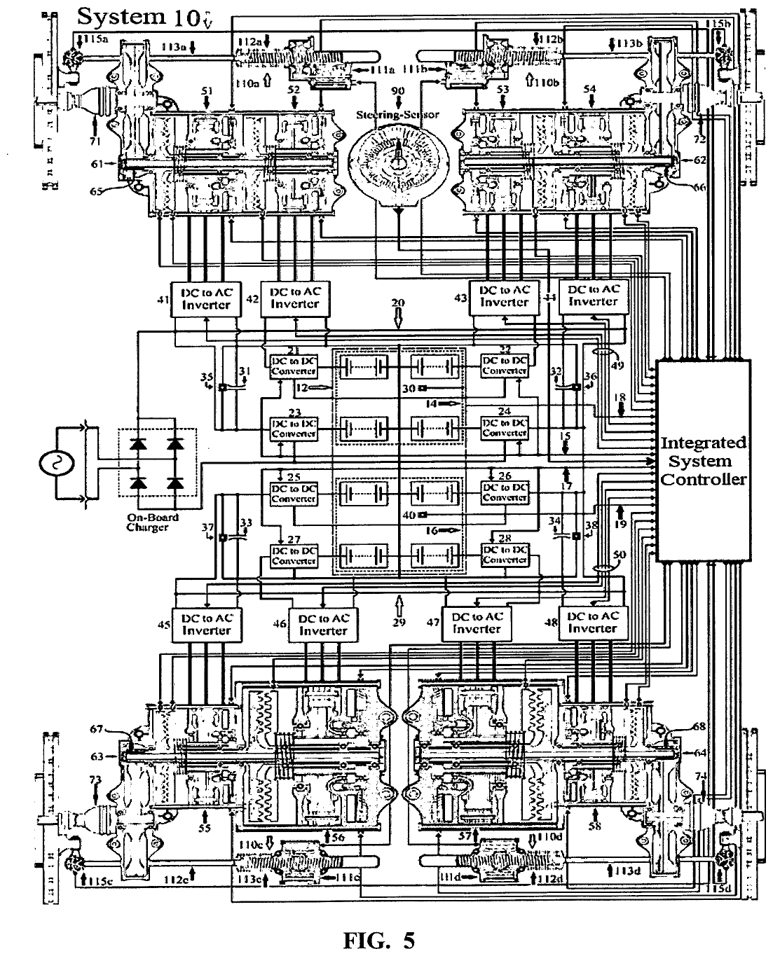

Referring now to the drawings wherein like reference numerals are used to identify identical components in the various views. FIG. 5 is a block diagram view of system 10, which is one of infinite integrated all-wheel electric propulsion and steering according to an embodiment of the invention. As will be described in detail infra, propulsion and steering in system 10 may be configured in battery electric (BEV) propulsion system arrangement that splits power output between one or plurality of electro-mechanical devices. Another system may be configured as hybrid electric (HEV) propulsion system that includes an internal combustion engine in addition to one or more electro-mechanical propulsion devices. Additional hybrid combination of power may be configured with fuel cell electric vehicles (FCEV) that includes hydrogen fuel cell in addition to energy storage device[s]. The above configuration applies also to trucks, semi-trailers, busses and all-purpose vehicles.

Digitized, Awd-System with Differently-Designed Motors

In various embodiment of this invention, the AWD propulsion segment of system 10 is configured to be incorporated into various types of vehicles, including but not limited to, automobiles, buses, light-duty trucks, semi-trailers, commercial and industrial vehicles such as mining and construction equipment, marine craft, aircraft, off-road vehicles, and personal carrier vehicles.

Propulsion system 10 may include a singular, or divided energy storage-system 12, with front energy storage 14 and rear energy storage 16. Each energy storage unit 14, 16 may have four positive terminals that are directly connected to each individual bi-directional DC-DC Converter, 21, 22, 23, 24, 25, 26, 27 and 28. Each energy storage unit 14, 16 may also have four negative terminals that are directly connected to each individual bi-directional DC-DC Converter, 21, 22, 23, 24, 25, 26, 27 and 28. Each of the energy storage units 14, 16 may have a separate or an integrated power management energy storage system [not shown], which may be configured as a battery management system. According to another embodiment, DC-DC converters 21, 22, 23, 24, 25, 26, 27 and 28 are bi-directional buck/boost voltage converters.

In energy storage units 14, 16, within system 10, sensors 30, 40 may be provided to monitor and calculate the state-of-charge of energy storage units 14, 16. According to one embodiment, sensors 30, 40 may include voltage and current sensors configured to measure the voltage and current of first and second energy storage units 14, 16 during operation of system 10.

According to various embodiment, first and second energy storage units 14, 16 may include one or more energy storage or energy producing devices such as batteries, ultra-capacitors, photovoltaic cells, flywheels, fuel cell or a combination of all five components, in various percent of their representation within each energy storage units 14, 16. Other embodiment may be where energy storage units 14, 16 incorporate ultra-capacitors with numerous capacitor-cells couple to one another, where every single capacitor-cell may have a capacitance between 500 and 3000 Farads—or greater. Ultra-capacitors offer nearly instantaneous power bursts during periods of peak power demand, therefore they may be implemented as secondary energy source that complements primary sources with batteries that suffer fast deterioration when repeatedly providing quick bursts of power; and since traditional battery energy storage have problems supporting high-power features—such as frequent start-stop vehicle applications, especially at lower temperatures—a secondary energy source with ultra-capacitors may be utilized to overcome this limitation.

In different embodiment, first and second energy storage units 14, 16 may be high power battery, with density more than 800-Wh/Kg. Other embodiment may be where energy storage units 14, 16 integrate high density batteries detailed above, in combination with several ultracapacitors.

In other embodiment, first and second storage units 14, 16 are a low-cost lithium ion battery. Alternatively, first and second storage units 14, 16 may comprise of a Silicon or Magnesium-anodes in Lithium-Sulfur battery; Sodium metal hydride battery; a Sodium Sulfur battery; a Nickel metal hydride battery; a Zinc-air battery, a Lead-Acid or any other combinations of low-constituent battery.

Propulsion system 10 may include: four bi-directional DC-DC converters 21, 22, 23 and 24, as integral components of the propulsion of the front wheels; and four bi-directional DC-DC converters 25, 26, 27 and 28, as integral components of the propulsion of the rear wheels, which are coupled across the positive DC link 20 and link 29 in the front and the rear bi-directional DC-DC converters respectively. The negative link begins in energy storage units 14, 16, and is coupled on the negative side of each component in system 10.

System 10 may include front left bi-directional DC-DC converters 21, 23 that may be connected across the positive and the negative DC link with DC bus 31 that may be connected to voltage sensor 35 to monitor the bus voltage. Bi-directional DC-DC converters 22, 24, 25, 27, 26 and 28 may maintain the same set-up as bi-directional DC converters 21, 23 respectively; that is, DC bus 32, 33 and 34 may be connected in parallel with a separate voltage sensor 36, 37, 38 to monitor the voltage in DC bus 32, 33 and 34 respectively.

To reduce the number of components in system 10; a different embodiment may be fitted where the front and rear energy storage units 14, 16 may be equipped with specific batteries that the respective bi-directional DC-DC converters may be left out. This will simplify production and reduce overall production cost. In such embodiment, a solenoid may be provided to selectively couple energy storage units 14, 16 to the respective DC bus.

All bi-directional DC-DC converters 21, 22, 23, 24, 25, 26, 27 and 28, when in use, are configured to convert one DC voltage to another DC voltage either by bucking or boosting the DC voltage. According to one embodiment, each bi-directional DC-DC converter 21, 22, 23, 24, 25, 26, 27 and 28 includes an inductor coupled to a pair of electronic switches and coupled to a pair of diodes. Each switch is coupled to a respective diode, and each switch/diode pair forms a respective half phase module. Switches may be isolated gate bipolar transistors (IGBT), metal oxide semiconductor field effect transistors (MOSFET), silicon carbide (SiC) MOSFET, gallium nitrite (GaN) devices, bipolar junction transistors (BJT), and metal oxide semiconductor-controlled thyristors (MCT).

In system 10, both energy storage units 14, 16 may be coupled via DC bus 31, 32, 33 and 34 to all electro-mechanical device or any other combination of partial loads. The controller may actuate any number of electro-mechanical devices in any driving mode, speed or load conditions, using multi-objective optimization algorithm to determine which of the electro-mechanical device configurations would consume the least Kw in any given driving mode to reach the best, most efficient propulsion.

In one embodiment of system 10, each DC to AC inverter 41, 42, 43, 44, 45, 46, 47 and 48 includes six half phase modules that are paired to form three phases, with each phase is coupled between the positive DC links 20, 29 of the DC bus 31, 32, 33 and 34 and the overall negative links of system 10.

Each electro-mechanical device 51, 52, 53, 54, 55, 56, 57, and 58 includes a plurality of winding coupled to respective phases of its respective DC-to-AC voltage inverter 41, 42, 43, 44, 45, 46, 47 and 48. The arrangements and design of the electro-mechanical devices 51, 52, 53, 54, 55, 56, 57, and 58 is limitless. Electro-mechanical devices 51, 52, 53, 54, 55, 56, 57, and 58 may either be a variety of AC motors, DC motors, fraction motors, and/or alternators. It is contemplated thus, that three-phase inverters 41, 42, 43, 44, 45, 46, 47 and 48 described herein may utilize any number of phases in alternative embodiment.

According to other embodiment, system 10 could be configured as genuine electric propulsion and steering. Alternatively, system 10 could be configured in a hybrid electric vehicle (HEV) propulsion system, which also includes an IC engine [not shown], coupled to electric propulsion system by mean of shared transmission [not shown]. System 10 could be configured in as fuel cell electric vehicles (FCEV) propulsion system, which also includes fuel cell [not shown] that may be coupled to different design of energy storage unit 14, 16.

Propulsion and steering system 10 may include geared power-transmissions [not shown in detail], 65, 66, 67 and 68 coupled to four joint shafts 61, 62, 63 and 64 that may be shared by two electro-mechanical devices when actuated by controller 100. The four-geared power-transmissions 65, 66, 67 and 68 [not shown in detail], may be constructed as single or multi-gear drive assemblies; toothed belt drive; chain drive assemblies or combinations thereof, according to innumerable embodiment. According to other embodiment, four geared power-transmissions 65, 66, 67 and 68 [not shown in detail], may be configured as electronic-variable transmission (EVT) that couples the outputs joint shafts 61, 62, 63 and 64 of electro-mechanical devices 51, 52, 53, 54, 55, 56, 57, and 58 to an internal planetary gear [not shown]. In operation, electro-mechanical devices 51, 52, 53, 54, 55, 56, 57, and 58, may be operated interchangeably over their specific high-efficiency range of bi-directional speed, torque and power commands to minimize energy loss and maintain high degree of overall system efficiency while system 10 is operating in either charge depleting (CD) or charge sustaining (CS) mode of operation.

The power outputs of four geared power-transmissions 65, 66, 67 and 68 are coupled directly to each corresponding driveshaft 71, 72, 73 and 74 of the vehicle since no differentials are necessary in the electric AWD propulsion and steering of system 10.

Controller 100 that runs and operates System 10 is connected to all eight bi-directional DC-DC converters 41, 42, 43, 44, 45, 46, 47 and 48 by control lines 15, 17. In one embodiment, control lines 15, 17 may include a real or virtual communication data link that conveys the voltage commands to the respective bi-directional DC-DC converters 21, 22, 23, 24, 25, 26, 27 and 28. Through appropriate control of switches in the front bi-directional DC-DC converters 21, 22, controller 100 is configured to boost voltage of first energy storage unit 14 to higher voltage and to supply the higher voltage to DC bus 31, 32 during the various modes of propulsion. Likewise, through appropriate control of switches in the front bi-directional DC-DC converters 23, 24, controller 100 is configured to boost voltage of first energy storage unit 14 to higher voltage and to supply the higher voltage to DC bus 31, 32 during various modes of propulsion. In the same way, through appropriate control of the switches in the rear bi-directional DC-DC converters 25, 26 controller 100 is configured to boost voltage of second energy storage unit 16 to higher voltage and to supply the higher voltage to DC bus 33, 34 during various modes of propulsion. Likewise, through appropriate control of the switches in the rear bi-directional DC-DC converters 27, 28 controller 100 is configured to boost voltage of second energy storage unit 16 to higher voltage and to supply the higher voltage to DC bus 33, 34 during the various modes of propulsion.

Additionally, during charging or during regenerative mode of operation, controller 100 is configured to control switching bi-directional DC-DC converters 21, 22, 23 and 24 in the front of the vehicle; and bi-directional DC-DC converters 25, 26, 27 and 28 in the rear of the vehicle to buck voltage of DC bus 31, 32 in the front and DC bus 33, 34 in the rear and supply the bucked voltage to the respective first and second energy storage units 14, 16.

To fit this integrated all-wheel electric propulsion and steering in any vehicle, system 10 may be implemented in infinite configurations. The variables may include the number and design of the electro-mechanical devices, the power and torque rating, and the design of the algorithm inside the logic data base of controller 100. System 10, as depict in FIG. 5, is configured to operate with eight electro-mechanical devices that are divided into four identical pairs. Each pair may comprise of similar construction, design, torque and power output. During any driving mode, controller 100 is configured to operate at least one electro-mechanical pair. Therefore, front electro-mechanical pairs 51, 54 and/or 52, 53; and rear electro-mechanical pairs 55, 58 and/or 56, 57 or any combination thereof, may be actuated simultaneously at the same time. However, since ‘electro-mechanical pair’ are always installed on opposite sides of the vehicle, to maintain balanced propulsion, controller 100 may operate a specific pair of electro-mechanical devices at the same time, but may elect to, and maintain diverse torque and speed (RPM) between the two electro-mechanical devices in turning modes and in slippery roads or in any other driving conditions that such diversion of the same torque and RPM is required.

In all propulsion and steering modes, controller 100 is coupled individually to all four DC to AC voltage inverters 41, 42, 43 and 44 in the front of the vehicle through control lines 49. Controller 100 is also configured to control the half phase modules of the front DC to AC voltage inverters 41, 42, 43 and 44 to convert the DC voltage on DC bus 31, 32 to AC voltage for supply individually to each electro-mechanical device 51, 52, 53 and 54, as part of the front propulsion. Starting propulsion from zero, changing speed in acceleration or deceleration, controller 100 may increase or decrease the voltage and increase or decrease the frequency modulation in selected DC to AC inverters 41 42, 43 and 44, through lines 49, with which the revolutions—in electro-mechanical devices 51, 54 or 52 and 53, or in all four electro-mechanical devices together—are boosting or bucking to increase or decrease the speed of the vehicle.

Similar operation takes place through control line 50. Controller 100 is configured to control the half phase modules of the rear DC to AC voltage inverters 45 46, 47 and 48 to convert the DC voltage on DC bus 33, 34 to AC voltage for supply to electro-mechanical devices 55, 56, 57 and 58 as part of the rear propulsion. Starting propulsion from zero, changing speed to acceleration or deceleration, controller 100 may increase or decrease the voltage and increase or decrease the frequency modulation in selected DC to AC inverters 45, 46, 47 and 48, through lines 50, with which the revolutions—in electro-mechanical devices 55, and 58 or in electro-mechanical devices 56, and 57 or all four electro-mechanical devices together—are boosting or bucking to increase or decrease the speed of the vehicle. DC to AC inverters, and electro-mechanical devices may be different in size and specifications. Nevertheless, controller 100 MO does not change thus, it may be programmed to fit all kind of specifications.

In a regenerative [charge sustaining] mode, controller 100 is configured to control DC to AC voltage inverters 41, 42, 43 and 44 in front of the vehicle through control lines 49 to invert an AC voltage received from its corresponding electro-mechanical devices 51, 52, 53 and 54 into a DC voltage to be supplied to DC bus 31, 32. Similar condition of operation takes place through control line 50 in the rear of the vehicle, which may contain the same configuration as the front of the vehicle.

As part of the operation of controller 100, the controller may receive feedback from plurality of sensors, or transmit control commands to other components within the propulsion and steering operation. In this instance of system 10, controller 100 receives via control line [not shown], specific feedback from voltage sensors 35, 36 coupled in parallel to DC bus 31, 32; and from energy storage unit sensor 30 via control line 18. Controller 100 also receives via control line [not shown], specific feedback from voltage sensors 37, 38 coupled in parallel to DC bus 33, 34; and from energy storage unit sensor 40 via control line 19.

The Ultimate All-Wheel Electronic Steering

The steering portion of system 10 is configured to be incorporated into various embodiment, in miscellaneous types of vehicles, including but not limited to, automobiles, light-duty trucks, delivery trucks, buses, semi-trailers, commercial and industrial vehicles such as mining and construction equipment, marine craft, aircraft, off-road vehicles, material transport vehicles and personal carrier vehicles.

According to the embodiment of the present invention, at some point during vehicle steering—as pre-programmed in the data base—controller 100 may apply various speeds to the left- and/or the right-side wheels; and concomitant, activate all four steering electro-mechanical devices, to position each wheel facing the turning center, which is the central part of this integrated propulsion and steering disclosure, as depicted in FIG. 27.

To achieve the precise steering maneuver—which is to steer and propel all 4-wheels at the same time—the following steering steps must be fulfilled:
(i) Electro-mechanical propulsion devices should operate most of the time in their optimal range of operation.
(ii) The EV propulsion should be integrated in the vehicle steering, for better efficiency, stability, and much better handling. Integration of propulsion and steering will also dispose of power steering gears, and redundant mechanical unnecessary items, to improved efficiency and save production cost.
(iii) During low-speed steering, all four wheels may be positioned perpendicular to the turning-circle center to get rid of wheel dragging (see FIG. 27), depending on the velocity of the EV.
(iv) In velocities above 35 mph, the rear-wheels may be positioned at the same direction as the front wheels, not necessarily the same angle. The exact rear-wheels angle may be determined with empirical testing since it depends on the vehicle's wheelbase, the distance between the left-side and right-side wheels, the vehicle weight, center of gravity, and use of the vehicle; and
(v) In multi-wheel vehicles, AW-steering will stabilize the vehicle and improve efficiency to a greater extent than light duty vehicles. When changing the steering angle of the steered front axle, the longitudinal axis of the vehicle must be taken into consideration and stored in the controller's data base, to provide individual, and accurate forced angle for each steerable wheel in the back of the trailer. This will also comply with NHTSA's new FMVSS 136 for semi-trailer and certain buses with GVWR of 26,000 Lb. [about 12,000 Kg], which will reduce untripped-rollovers, and mitigates severe understeer or oversteer conditions that usually leads to loss of control.

Steering a vehicle begins when the driver or the AV (AV) ECU elects to change the direction of the vehicle. FIGS. 28, and 29 depicts two distinctive configurations of driver's steering-sensor 90 [in FIG. 5] as part of the steering-wheel. The only moving part of the steering-sensor is pointer 94a that is permanently fixed to the steering-wheel's column 91a [shown in cross-section] and is moving whenever the steering-wheel changes position. Therefore, whenever the driver turns the steering-wheel, column 91a causes pointer 94a to slide on leaflets 92a until the driver stops the steering-wheel's movement and pointer 94a is having continuous contact with a specific leaflet, which represents the driver's desired angle to where the vehicle should be steered. In AV, if there is no steering wheel, the ECU may move pointer 94a with a stepping-motor whenever the ECU elects to steer the AV. Pointer 94a may also be configured with an upper sliding contact 97a, and a lower sliding contact 98a that may be connected to each other by electronic means. The lower sliding contact 98a is in continuous contact with sliding ring 95a connected to controller 100 by electronic means to create closed-loop circuit in the following sequence: steering-sensor 90—specific leaflet 92a—upper-pointer contact 97a—lower-pointer contact 98a—controller 100—wheel steering-motor 116 [in FIG. 32]—wheel-position sensor 115—back to controller 100. When the pointer's upper contact stops over specific leaflet, it closes through the lower contact an electronic circuit with controller 100. This specific close-circuit is recognized by controller 100 as pre-programmed leaflet No. n°. For example, turning the steering wheel to leaflet No. 26 on the right side of steering sensor 90 means the driver or the autonomous ECU sent a command by electronic means to controller 100 to turn the vehicle to 26°, which means—the specific contacted leaflet is the steering angle the driver or the AV ECU elected to take.

FIG. 28 is configured by way of sensor-neuron layout, following human's physiology; one sensor-cell, one neuron transmitting electronic information directly to the [controller] brain. The benefit of such set-up is to ensure that if one sensor cell stops functioning, the neighboring cells [leaflet] is within range to cover-up for the failing cell by transmitting the information to the brain. The subject steering sensor similarity to human's sensor-neuron configuration is an integral part of system 10 and is shown in detail in FIG. 28, which comprises of thirty contact leaflets 92aR with individual direct wire 93aR connection to controller 100 from the right half of the steering sensor; and thirty contact leaflets 92aL with individual direct wire 93aL connection to controller 100 from the left half of the steering sensor.

If one contact leaflet is defective, broken, disconnected or malfunctioning, controller 100 may be programmed to utilize the last and/or the next leaflet reading—which may be just 1° difference between the leaflets—to keep the wheel within safe range of only 1.66% error; and activate specific warning signal to alert the driver of the malfunctioning leaflet. This fail-assist maneuver complies with NHTSA's “fail operational systems” for steering.

The steering-sensor configuration in FIG. 29 is simpler and inexpensive to manufacture. The resistors are connected in series and each resistor may have the same or different resistance. Therefore, steering-sensor in FIG. 29 is configured as “add-on” resistance. Controller 100 recognizes a specific leaflet, i.e. specific steering angle by the resistance in the circuit, which is the sum of the resistors added from the top [resistance zero] to leaflet n° where pointer contact 97b stopes. However, according to Ohm's law, resistance is the ratio between voltage and current, then in fluctuations of voltage or current within system 10, controller 100 reading may be somehow different than what it was set for. Additional deficiency is the resistors being connected in series. Any malfunction of a single resistor will cause brake-down of the left or right side of the sensor after the broken resistor. Therefore, steering-sensor 90 as configured in FIG. 28—emulating human physiology—is much more reliable than any other configuration available.

In the embodiment of system 10, steering-sensor 90, comprises of sixty leaflets, thirty for the right turns, and thirty for the left turns. Each leaflet represents a specific angle [in degrees], which is pre-programmed in the data base of controller 100. However, in different configurations, a leaflet may represent any angle; and the number of leaflets on each side of the steering sensor may be elected to fit specific vehicle's applications.

The Integration of the Propulsion with the Steering

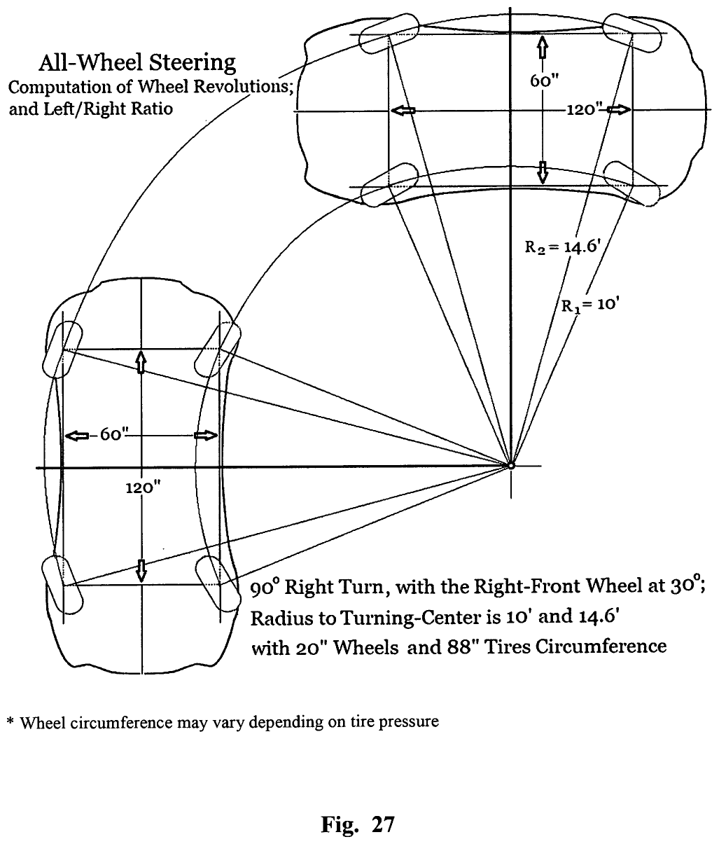

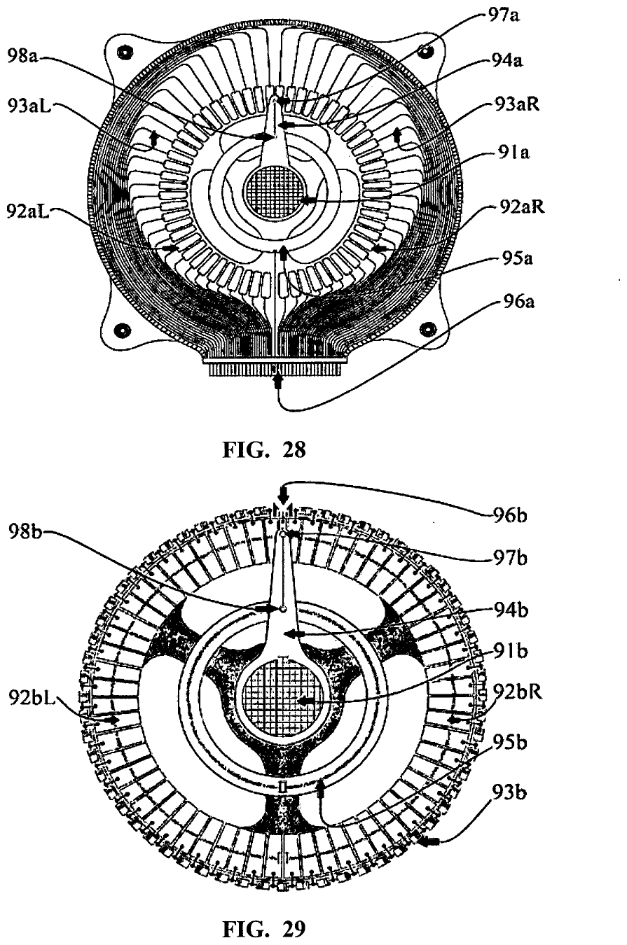

The integration of the propulsion into the steering process begins when the driver moves the steering-wheel to a position other than 0°. In AVs, it begins when the ECU initiates a specific turning mode. As a part of system 10, the vehicles schematics in FIGS. 26 and 27 are configured with 120″ wheel-base, with 60″ distance between the front-wheels; with 60″ between the rear-wheels; and tire circumference of 88″. When the driver for instance, gradually moves the steering-wheel to leaflet 30° to make a 90° turn at 30 mph, controller 100 may keep the electro-mechanical propulsion devices on the front-right and rear-right wheels at 30 mph.

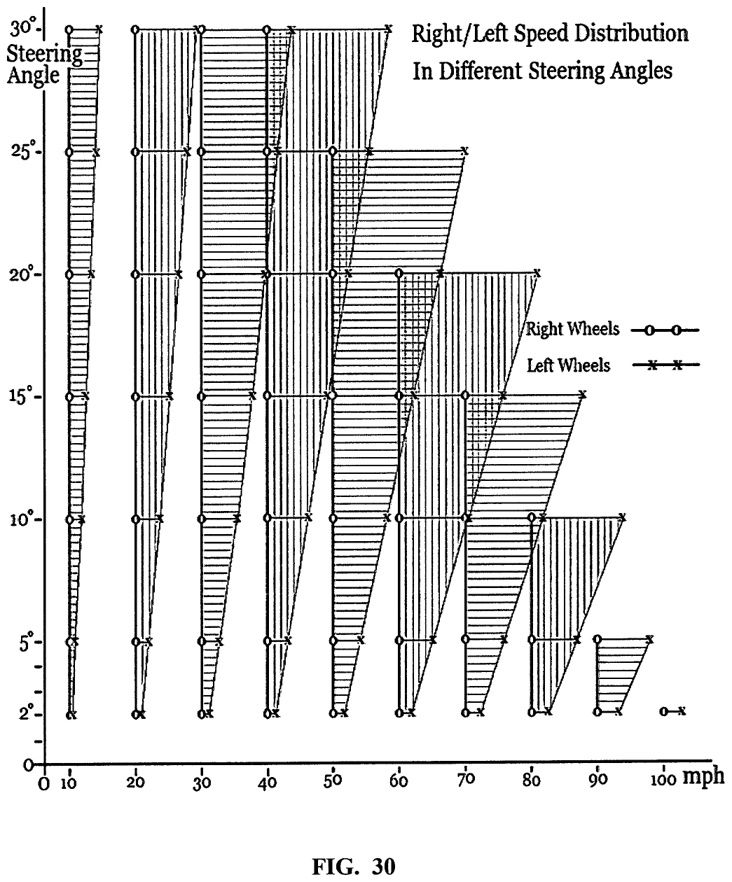

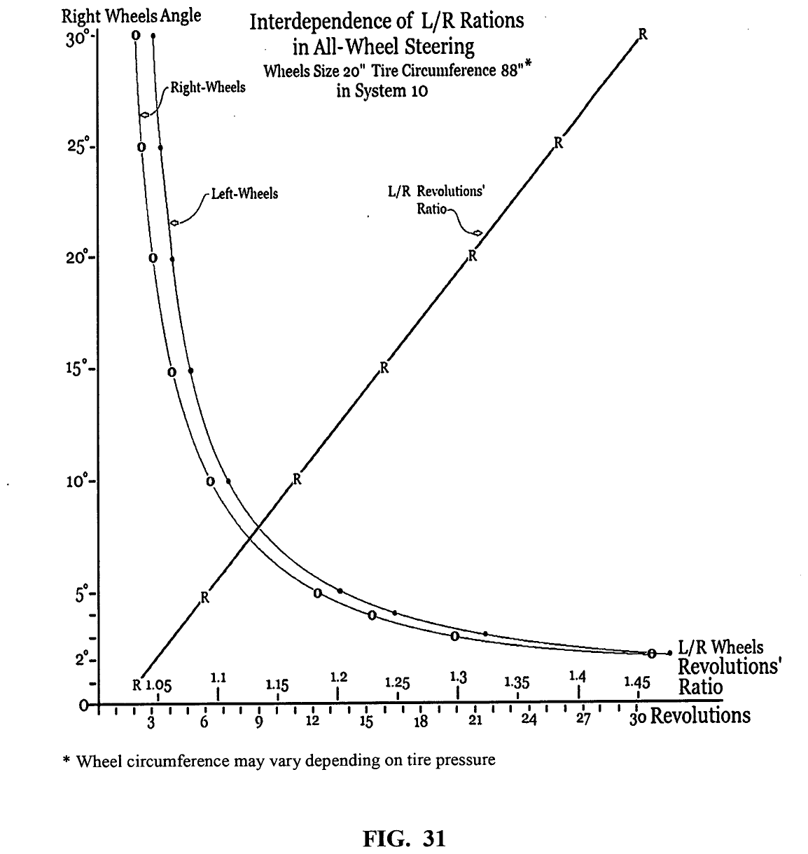

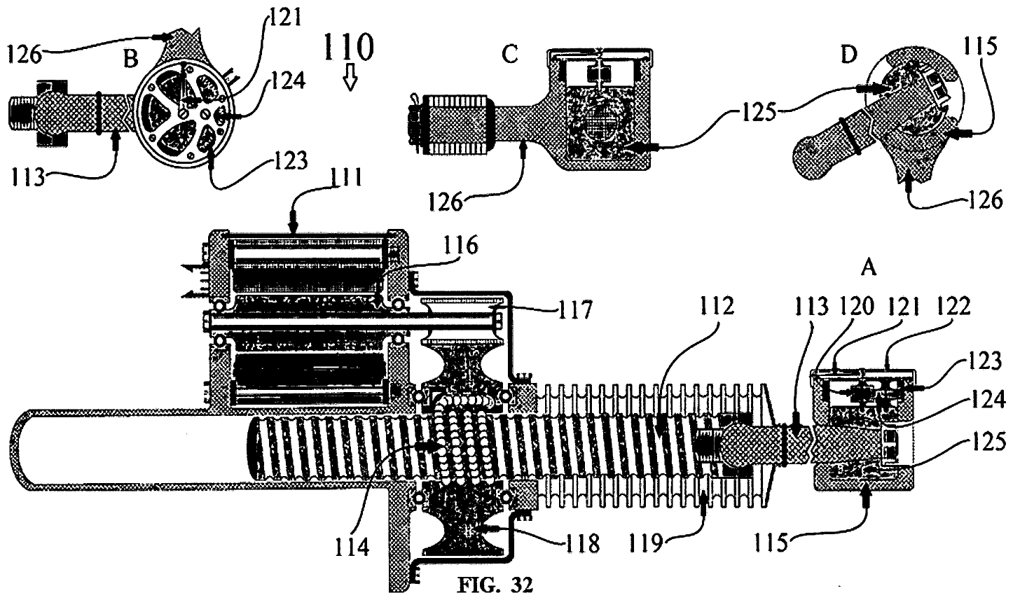

FIG. 27 also indicates that the distance to center of turning-circle for both left wheels is about 50% greater [14.6′] than the distance to center of turning-circle for both right-wheels [10′], the left wheels has to travel longer distance—at the same time period as the right wheels—to make a perfect turn. Controller 100 may gradually move-up the electro-mechanical devices speed on the left side of the vehicle from 30 mph in straight-forward driving, to 43.6 mph (see FIGS. 30 and 31); or translate the speed into measured revolutions at a 30° front-right wheel angel—to gradually make a 90° direction-change to the right—the right-wheels will need 2.1477 revolutions, while the left wheels 3.1230 revolutions, to make a perfect turn without assistance of EPS (see FIG. 31). This perfectly calculated electronic AW propulsion and steering is impossible to pull off with typical mechanical means.

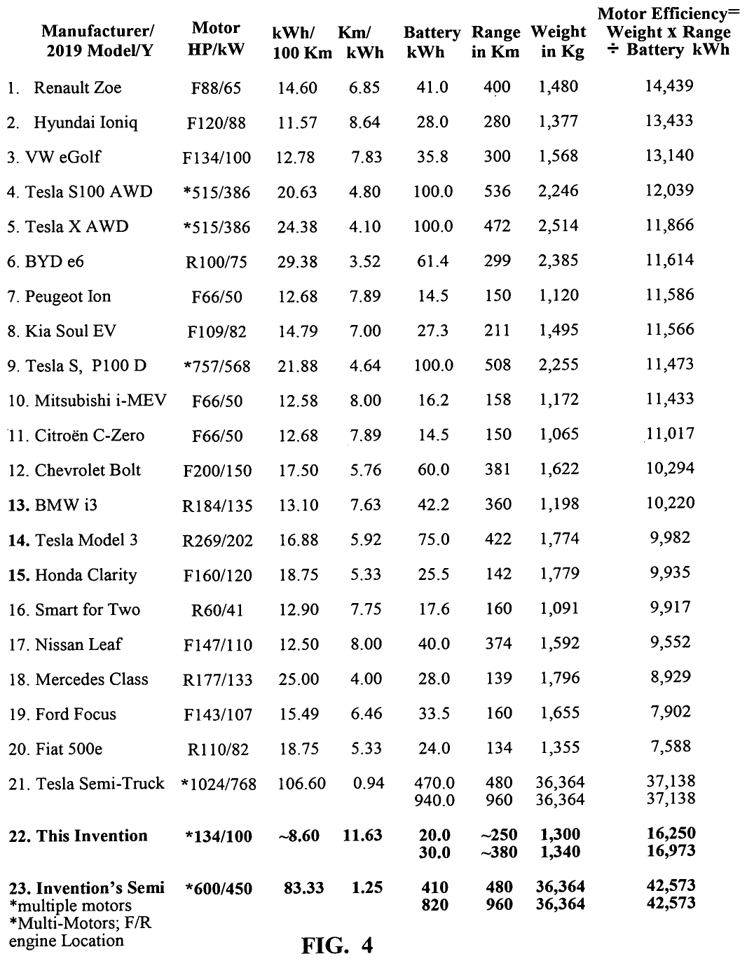

Gradually turning steering sensor 90 [in FIGS. 4 and 27] to number 30 leaflet [30°]², triggers an initial input of steering information. Controller 100 utilizes multi-objective optimization algorithm to simultaneously determine each individual wheel's steering angle and speed [angular revolutions]. The intricated process takes the following steps:
(i) Controller 100 (in FIG. 5) actuates the front-right electro-mechanical steering device 111b in steering assembly 110b to gradually bring the front-right wheel to 30°. Controller 100 continuously receives electronic information from wheel-position sensor 115b about the changing position of the right-front wheel. When wheel-position sensor 115b informs controller 100 that the right front wheel reached the angle of 30°; controller 100 stops electro-mechanical steering device 111b. ²0° to 180° is always the right-side; and 181° to 360° is always the left side.

Simultaneously, the front-right wheel speed may be reduced, remain unchanged or increased (see FIGS. 27, 30 and 31).
(ii) The same steering procedure follows when controller 100 actuates the front-left electro-mechanical steering device 111b in steering assembly 110a to gradually bring the front-left wheel to 20.1°. Controller 100 then continuously receives electronic information about the changing position of the left-front wheel from wheel-position sensor 115a. When wheel-position sensor 115a informs controller 100 that the left-front wheel reached the angle of 20°; controller 100 stops electro-mechanical steering device 115a.

Simultaneously, the front-left wheel speed—in case where the front-right wheel's speed remains unchanged—will be gradually increased to 43.6 mph to make a perfect turn without a standard EPS (see FIGS. 27, 30 and 31).
(iii) Controller 100 actuates the rear-right electro-mechanical steering device 111d in steering assembly 110d to gradually bring the rear-right wheel to 330°. Controller 100 then continuously receives electronic information about the changing position of the right-rear wheel from wheel-position sensor 115d. When wheel-position sensor 115d informs controller 100 that the right rear wheel reached the angle of 330°; controller 100 stops electro-mechanical steering device 111d.

Simultaneously, the rear-right wheel speed may be reduced, remain unchanged or increased. It usually matches the front-right wheel's speed (see FIGS. 27, 30 and 31).
(iv) The same procedure follows when controller 100 actuates the left-rear electro-mechanical steering device 111c in steering assembly 110c to gradually bring the rear-left wheel to 340°. Controller 100 then continuously receives electronic information about the changing position of the left-rear wheel from wheel-position sensor 115c. When wheel-position sensor 115c informs controller 100 that the right-rear wheel reached the angle of 340°; controller 100 stops electro-mechanical steering device 111c.

Simultaneously, the rear-left wheel speed—in case where the front-right wheel's speed remains unchanged—will be gradually increased to 43.6 mph to match the front-left wheel speed (see FIGS. 27, 30 and 31).

Since at 30° steering the right wheels' turning center has only a radius of about 10′, a 43.6 mph or even 30 mph velocity is not realistic because it may knock the vehicle off balance. While the relationship between speed and turning angle could be empirically determined for each vehicle or calculated by using wheel-base measurements, weight distribution and center of gravity; in the model of 43.6/30 mph turn, the controller is configured to execute control logic stored in a data base associated with the stability of the vehicle. Controller 100 can determine the highest permissible speed at 30° turning mode that will keep the vehicle's velocity below the speed that might endanger the vehicle stability. The program stored in Controller 100 may allow the driver to make the 30° turn safely, yet, only in permissible speed; no matter how hard the driver pushes the accelerator-pedal.

Beside the safety issue, without the ‘overturn prevention system,’ drivers would nervously apply the braking-system, trying to stabilize the vehicle and in the process drive down efficiency. In view of stability benefits—while the propulsion system is involved in the steering process—a vehicle could easily manage lateral acceleration of 0.07 g in 30° turning mode without to apply the braking system. The same applies to AVs because every time brake pads are applied; it cuts down in the vehicle efficiency.

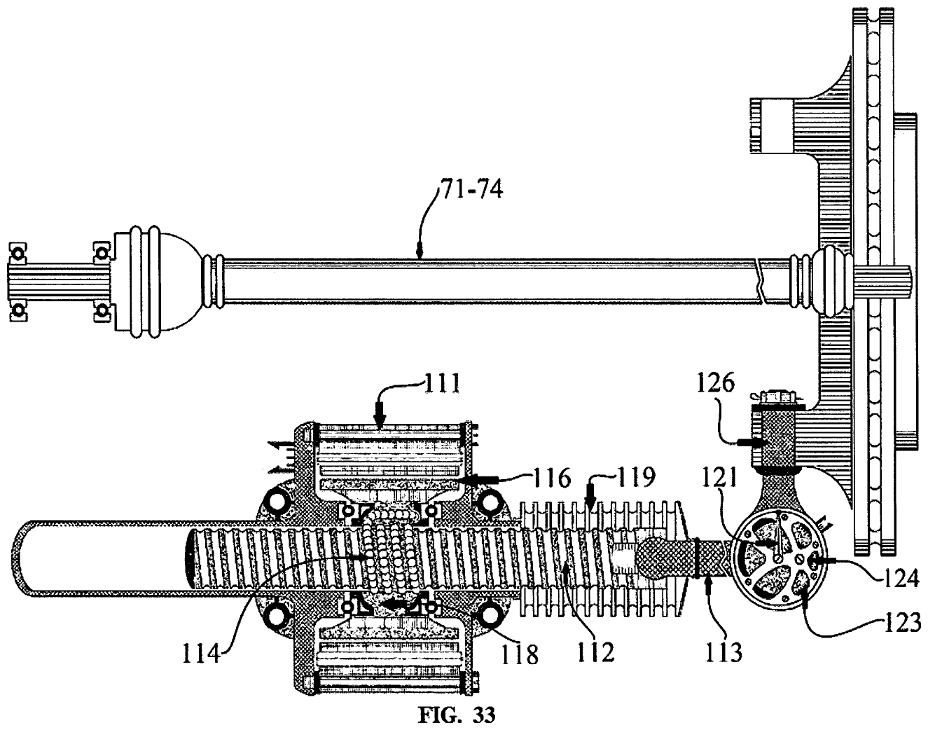

Steering assemblies as depicted in FIGS. 32 and 33, although differently configured, are maintaining similar MO. Steering assemblies 110a, 110b in the front of the vehicle, and steering assemblies 110c, 110d in the rear of the vehicle may differ in their electro-mechanical configurations. The front steering configuration 110a, 110b in FIG. 5, may be equipped with more powerful fast acting electro-mechanical devices than the rear assembly 110c, 110d to act instantly in response to any steering commands from controller 100. The choice of electro-mechanical devices 111 for the front wheels can be any device, from DC motors, three phase AC motors, DC brush-less motor or any other design of electro-mechanical device.

To push or pull the wheels to the proper angle, system 10 embodiment utilizes ball-screw 112 as a device for converting electro-mechanical rotation of the electro-mechanical device 111 into linear motion of the outer tie rods 113. To minimize friction in ball-screw 112, bearing balls 114 are captured between the nut 118 and the screw-threads. Since controller 100 determines how far the outer tie rod 113 needs to travel to bring the wheel to the desired angle, electro-mechanical device 111 turns the ball-screw 112 and applies axial force through outer tie rod 113 directly to the modified into wheel-position sensor—outer tie rod end 115. Rotor 116 in the electro-mechanical device rotates a shaft that is configured with direct gear 117, or with toothed belt drive wheel [not shown], or with chain drive [not shown] or with any other form of power transmission to nut 118, which rotates and moves ball-screw 112 forward and backwards.

System 10 is configured with four-wheel-position-sensors 115 attached to each wheel's steering knuckle-arm to accomplish the same function as a mechanical tie-rod end, yet, at the same time the sensor monitors, and transmits by electronic means the precise wheel-position to controller 100. FIG. 32 depicts a wheel-position sensor in four different views for better perceive the sensor's usefulness. A depicts a central cross-section with the outer tie rod; B is a view from the top of the sensor; C is also a center cross-section but is 90° to A cross-section; and D is a view from the bottom. If the tie rod end is not a practical location for a wheel-position sensor, an alternative design of linear wheel-position sensor may be installed on the outer tie rod. The change in length of the outer tie rod may be utilized as scale for the wheel's angle.

A wheel-position sensor may in fact be configured as a miniature version of steering sensor 90 and may also be constructed that way. Pointer 121 is fixed to the axle of the center-gear 120, which is in tight contact with the teeth of a side-gear 124 and said side-gear teeth are in tight contact with teeth molded inside the wheel-position sensor housing 115. When the nut 118 rotates; the outer tie rod 113 is following the axial movement of screw 112 to the left or the right, triggering a change in the angle between outer tie rod 113 and knuckle steering arm 126, which is proportional to the change in the wheel's angle, i.e. to 0°. The proximate result is rotation of cylinder 125 inside wheel-position sensor's housing 115, triggers the movement of the toothed area 123, molded inside the wheel-position sensor housing, which initiates the following chain reaction: movement of toothed area 123 rotates toothed side-gear 124, which rotates center-gear 120, which causes the movement of pointer 121, that sends by electronic means the ‘change of position’ information to controller 100.

In situations where any of the wheel-position sensors is totally ‘out-of-order,’ controller 100 may be programmed to apply the reading of the opposite side wheel-position sensor to the defective side to keep the vehicle in relatively safe driving conditions and notify the driver by electronic means about the location and the cause of the malfunction. In AVs, a flushing-light and a buzzer will make the passengers aware of the malfunctioning device. This fail-assist maneuver complies with NHTSA's “fail operational systems” for steering. FIG. 31 depicts the revolution differences between the left and the right side of the vehicle, at the right wheel's angle. The difference is usually very small above 50 mph.

The myth that mechanical propulsion and steering is safer than electric propulsion and steering is no longer factual. It was vastly demonstrated supra that digital controls can monitor, calculate and actuate EV's aggregates in milliseconds, giving rise to precision in propulsion and steering, which translates also into safety; including but not limited to, electronic malfunction warning systems—as described in the steering section [0110] above-which correct defects by electronic means, and notifying the driver/owner of AV that the vehicle has malfunction that needs repair. Mechanical components brake because of defective materials installed during manufacturing; due to material wear and tear and/or deficient or lack of maintenance results in malfunctions that are not monitored because mechanical propulsion and steering system lack the electronic monitoring systems to inform the driver that the tie rod end is going to brake at the next 90° turn or that speeding at 40 mph in a 90° turn will cause a roll-over.

Integrated Propulsion & Steering for Heavy-Duty Vehicles

Heavy-duty trucks and semi-trailers are widely used for transportation of goods due to their low operation cost; and, since the world population is moving into cities, public transportation is expected to increase dramatically leading to increased number of buses for city and inter-cities transportation. So far, inherent to these class of vehicles, only electrification—in particular with this disclosure—will solve the vehicles' two paramount nuisances and complications they trigger off:
(i) massive pollution of CO₂ and NOₓ that triggers health detriments to living organisms, and diminishes the green-house gases in the atmosphere; and
(ii) extremely poor maneuverability. Drivers are shortcoming when they have to steer their heavy-duty trucks, buses and semi-trailers inside an urban areas to deliver goods or transport passengers.

The future semi-trailer's business is projected to be autonomous; well, the only way to bring about autonomous mobility for semi-trailers is propulsion and steering with digitized electronic means while the energy source could be batteries or fuel-cells, both of which provide electric power from different starting points. Traditional diesel engines in buses, heavy-duty and semi-trucks should be abandoned. FIG. 7 demonstrates the overall limitations of diesel engines. The operational level of torque in at 25-32 RPM, and the highest level of power is at 33-40 RPM, which justified the engineering of 10 to 18 gears transmissions to move very heavy load from zero to 60 mph within a 10-15 RPM window of effective diesel engine torque and power. The result, semi-trailers need more than 60 seconds, and the driver's “double-clutch hard labor” to get from zero to 60 mph, while electric semi-trailer manage to do the same in less than 20 seconds, fully loaded.

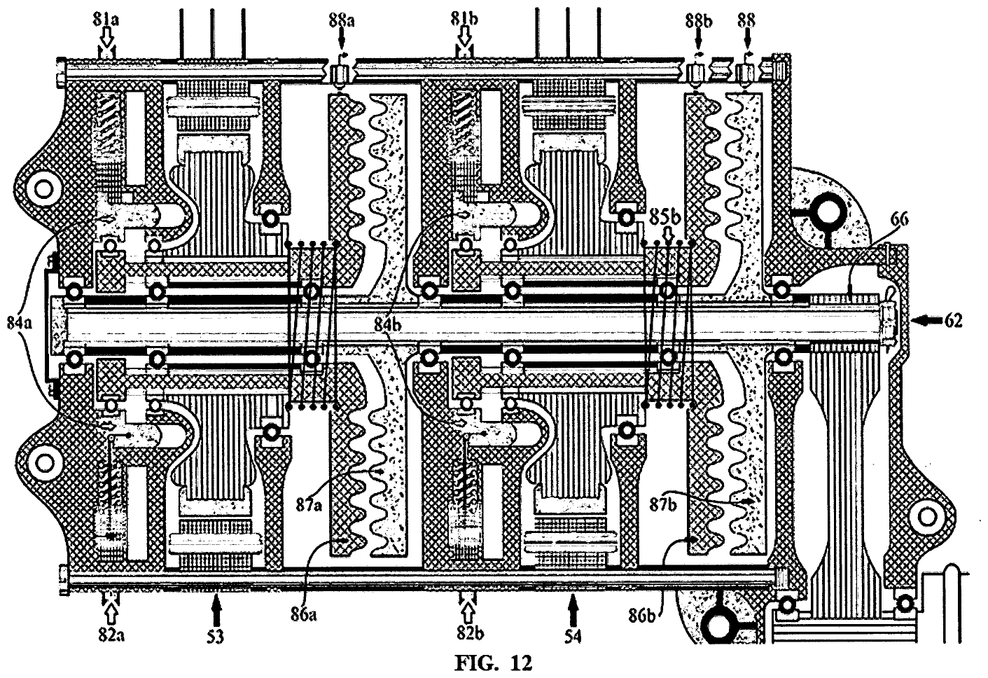

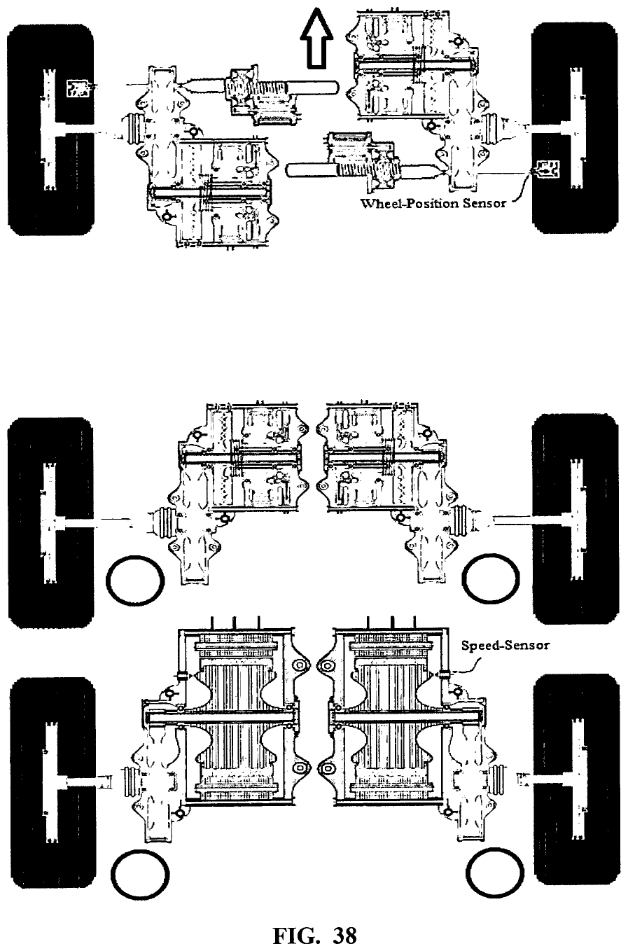

Current electric semi-trucks need numerous improvements to be economic viable, and profitable. It is not sufficient to just replace the diesel engine with four electro-motors and propel the same traditional rear-wheels of the tractor; or lower the tractor nose for better coefficient of drag, and continue to steer with the same traditional, mechanical system where only two front-wheels of the tractor are steering a 58′-feet long vehicle. Interpreting system 10 as depict in FIG. 5; then FIG. 38 could be the basic set-up of a propulsion and steering aggregate in the front 2-wheels of the semi-tractor, and a combination of two pairs of electro-mechanical devices, without the steering gears since the four or eight wheels of the tractor in the rear are practically in the middle of the semi-trailer, facing the center of turning in about 90°. This design concept may be applied to buses, heavy-duty trucks and semi-trailers by propelling and steering all, or less than all wheels with multiple and diverse electro-mechanical devices as depict in FIGS. 12-13 and 35-37 with the option to integrate in the steering process. FIG. 38 is a design of six, diverse electro-mechanical devices; some has coupling and de-coupling gears, and some does not; some has electro-mechanical devices that are steerable; and some does not. All these combinations—which are not available in diesel buses or semi-trailers—are to achieve: (i) superior efficiency; (ii) longer range; (iii) uniform distribution of propulsion power and weight along a 58′-feet long vehicle; (iv) remarkable maneuverability; (v) zero NOₓ pollution, and reduction in CO₂ [electricity production in power plants emits much lower CO₂]; (vi) reduction in battery-pack seize and cost; and (vii) lower manufacturing cost.

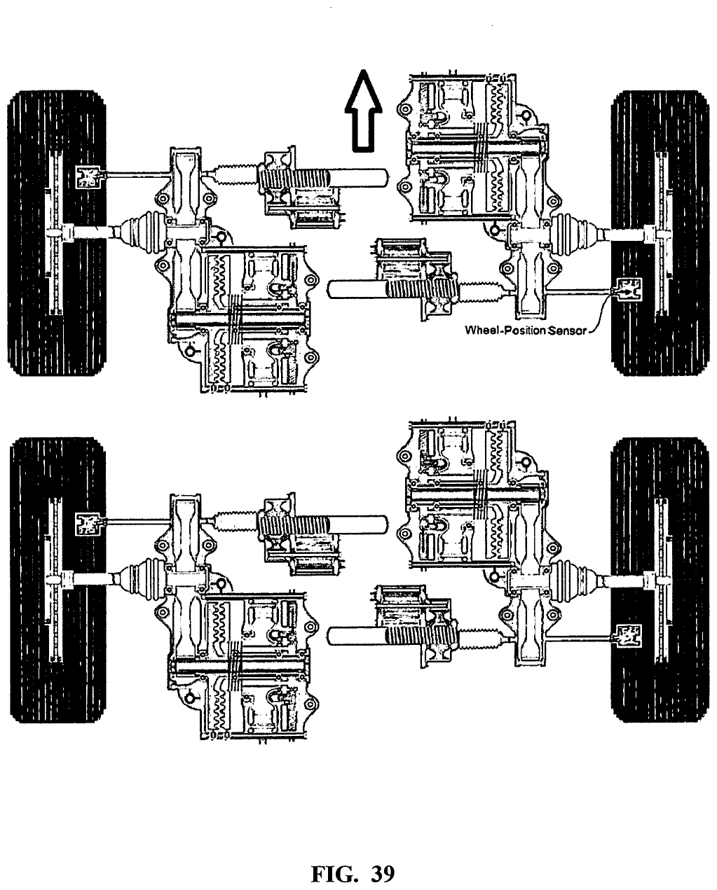

FIG. 39 is a design of four electro-mechanical devices that may be installed at the two rear-axles of a semi-trailer, equipped with dog-clutches to be de-coupled to save energy whenever their contribution to propulsion is not required; and All 4 or 8-wheels may be steerable

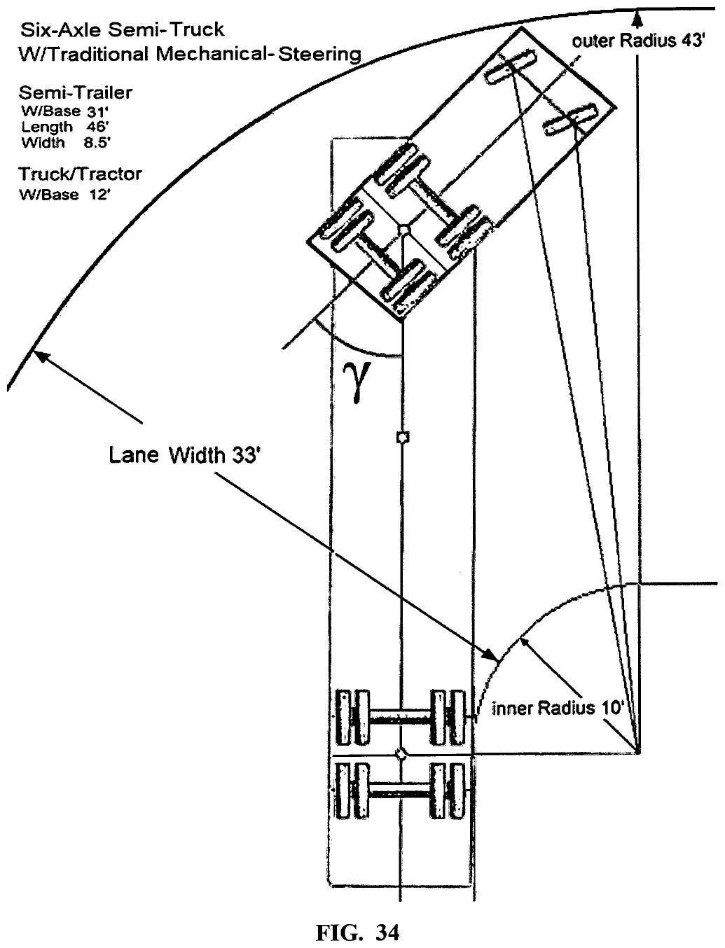

Steering an articulated vehicle, with only the front two-wheels is a massive obstacle not only to the semi-driver, but also to all other drivers on the road as presented in FIG. 34. The driver needs 33′-feet lane-width—which is almost three driving-lanes—to make a 90° turn. To program an autonomous semi-truck to steer a 58′ and longer articulated vehicle with only two steerable wheels in the very front, is absolutely mission impossible. Evolution—though it may seem inconsequential to automotive engineers—provided the very primitive caterpillar-worm a controlled mobility in every segment of the body, for a reason; because, with two front-legs, the worm would not be able to move the rest of his body. The eventual deduction is that power distribution in long vehicles—particularly in articulated vehicles—will rehabilitate the traditional, ill engineered semi-trucks maneuverability fortiori, when multiple electro-mechanical devices along the vehicle are integrated in the propulsion and the steering process.

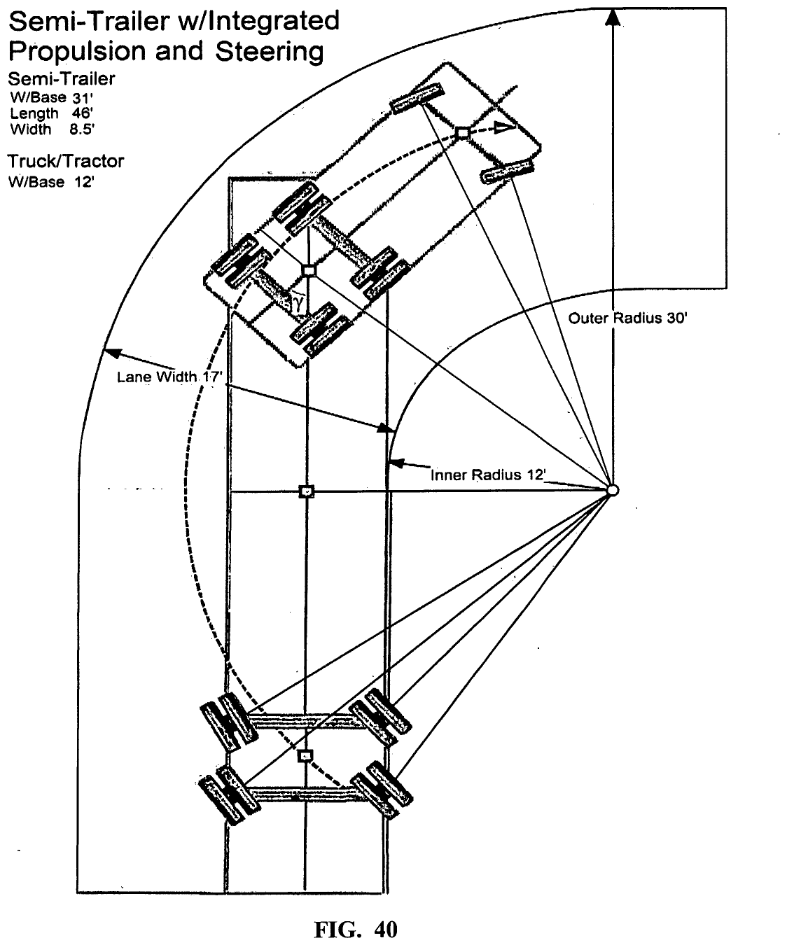

Low-speed multi-wheel vehicle's maneuverability was always a problem in resolving the amount of space required by the vehicle to make a turn as depicted in FIG. 34. One of the principal issues in fitting this disclosure in articulated vehicles, such as the one displayed in FIG. 34, is to reduce the maneuvering space, e.g., to minimize the width of the lane a semi-trailer will occupy while making the turn. Because, different articulation angles γ follow different curve radii; and the ratio between the minimum inner radius and the maximum outer radius [swept path] the vehicle uses during maneuvering, can be significantly larger than the width of the vehicle combination. Therefore, the trailer's two rear-axles has to be steered. FIG. 40 demonstrate the remarkable reduction in the outer radii, and reduction in articulation angle γ when the trailer's rear axles' wheels are steerable. The optimal setting is when the tandems center in the trailer is following exactly the same curve as the center front tractor axle (see dotted line in FIG. 40). It is obvious that the best way to achieve this goal is to steer the trailer's rear wheels to provide the trailer's center of tandems the capacity to match the curve radii of the tractor's front axle.

When the rear-axles are steered and propelled; this disclosure's design for heavy-duty and articulated vehicles will eventually provide much better result than just improve steering when propulsion is integrated in the steering process:
(i) It will result in dramatic improvement in vehicles maneuverability at low and high speeds, minimize off-tracking and a total swept path width, and overall, much better stability at any speed range because individual propulsion of each wheel causes equal power distribution along 58′ feet long tractor and trailer.
(ii) In low-speed steering modes, aligning the rear wheels of the trailer—at 90° to turning center (see FIG. 40) will reduce the Cᵣᵣ [Coefficient of rolling resistance]. Tires in traditional semi-trailer are dragged in lateral and longitudinal directions and are exposed to shear forces, leading to repeatedly tires blow-up, and to rise in maintenance cost. Steering the wheels will dramatically reduce tire wear and the maintenance budget.
(iii) 58′ Semi-trucks are much longer than cars, then the radii to the turning-center would be much longer, developing smaller speed differences between the left and the right wheels than is noticeable in passenger cars. Rear-wheel propulsion and steering will dramatically increase tire-grip on the road; and put a stop to the trailer when the tractor stops, which is a very common accident in semi-trailers.
(iv) Propelling the left and the right side of the tractor and the trailers wheels in different speed will perfect stability, ease maneuverability, and would eliminate the need of power-steering system altogether; and
(v) Like in system 10, the controller, or the autonomous semi-trailer's ECU may de-couple specific electro-mechanical devices when sufficient kinetic energy was built up—especially in highway driving, which is more than 90% of semi-trucks driving—to save battery energy, which results in extended driving range.
(vi) After evaluating the driver's desired steering angle, and the topographic GPS data, the controller may be programmed to calculate the specific propulsion power to each wheel, while calculating the steer-angle of all wheels. Then, compute which of the 10 electro-mechanical devices are to be utilized to propel; and in what angle each wheel will be steered in every point and time of mobility; which is much more sophisticated task than in 4-wheel passenger car, yet it is much closer to what evolution created in billions of years to make it the ultimate mobility.

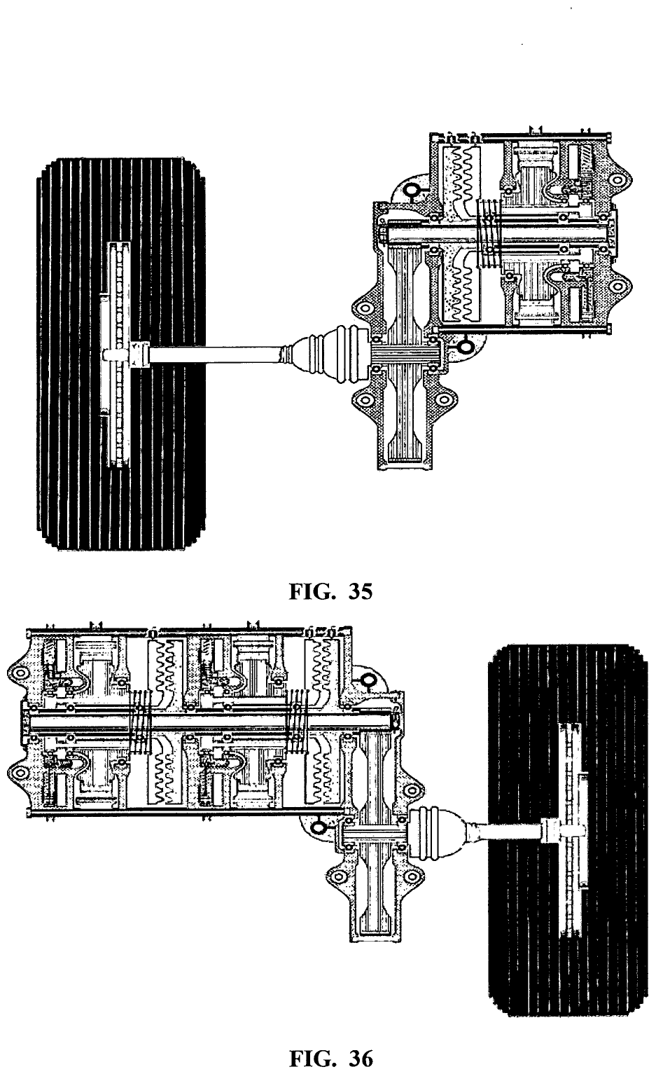

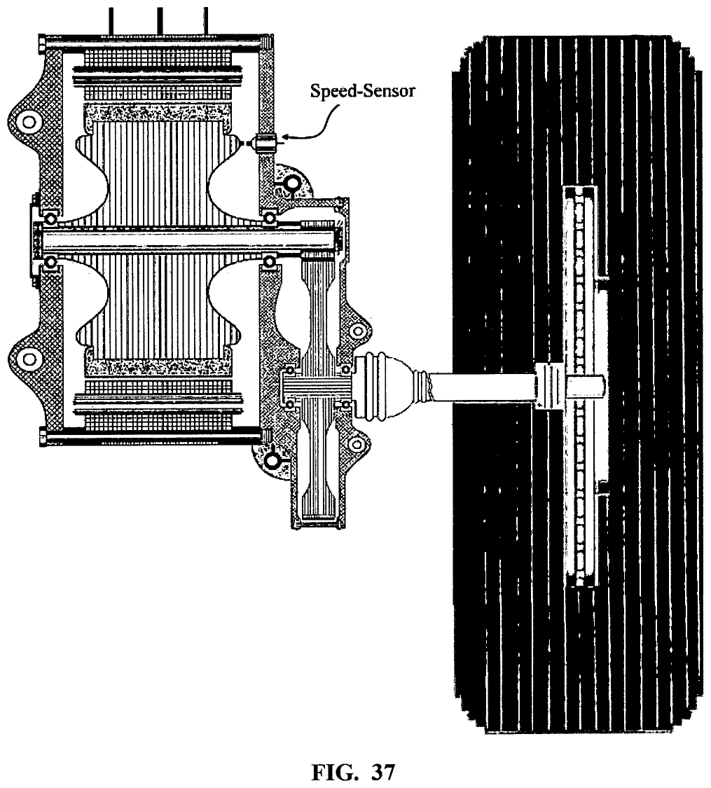

FIG. 35 is single electro-mechanical device with dog-clutch, manufactured with any specifications that could be installed in any heavy-duty trucks, buses or semi-trailers, usually with more than two axles to propel the vehicle with various, other electro-mechanical devices. FIG. 36 is the same design as FIG. 35; yet, it is manufactured with two electro-mechanical devices that could be installed in any heavy-duty trucks, usually with only two axles to propel the vehicle. FIG. 37 is a relatively large, single electro-mechanical device without dog-clutch. It may be manufactured with any specifications and could be installed in any light- or heavy-duty vehicles, buses or semi-trailers. It may be installed with steering gears [not shown]. This electro-mechanical device is designed to be the core propulsion that runs whenever the vehicle is in motion. The specifications of this electro-mechanical devices may be one-half plus 10% [these electro-mechanical devices are installed in pairs] the HP and torque required to propel the vehicle in 0° elevation, no wind and minimal road resistance.

The design of various electro-mechanical devices may secure that the vehicle never stops because power distribution among about various, and different electro-mechanical devices will eventually eliminate mechanical break-downs because, even though one or several electro-mechanical devices may malfunction, the rest will suffice to keep the vehicle running, which is a top priority, especially in the trucking industry to deliver goods on time. Utilizing induction motors will also eliminate the necessity of water-cooling system and overheating.

FIG. 38 displays a suggested design of six electro-mechanical devices for a semi-tractor. The front, single electro-mechanical devices pair are equipped with dog-clutches and are steerable. The middle single electro-mechanical devices pair are identical to the front ones and are equipped with dog-clutches, thus, they might have different specifications, and they are not steerable. The rear, single electro-mechanical devices, as depict in FIG. 37, have no dog-clutches and are not steerable.

FIG. 39 displays a suggested design of four electro-mechanical devices for the two rear-axles in the trailer. They might be designed with the same, or different specifications. However, all four electro-mechanical devices may be steerable and equipped with dog-clutches. The reason four electro-mechanical devices in the trailer are steerable and equipped with dog-clutches is because the two ends of the vehicle have to be steered, yet, the center of the articulated vehicle is perpendicular to turning center, and therefore the four tractor rear propulsion devices are not steered.

The design of the two, relatively large electro-mechanical devices in the rear of the tractor (see FIG. 38) is for a reason. Semi-trailers spent most of their driving at constant speed of 45-60 mph on the highways. The two fixed rear motors may be designed to move the fully loaded semi-trailer while all other electro-mechanical devices are decoupled, which will consume minimal amount of energy.

Manufacturing and maintenance cost computations is a very important issues when operating trucking business. Purchase price of a new, standard diesel eighteen-wheeler semi-tractor and trailer is about $170,000 where, standard tractor with diesel engine cost about $130,000; and standard trailer for 18-wheeler, cost about $40,000. Adding steerable rear-wheel system will cost at least additional $20,000; total $190,000. All estimates are on the low-side.

The same new tractor without diesel engine, transmission, drive-shafts and differentials; exhaust system; water-cooling system, pollution prevention system; power-steering system; starting system; alternator charging system; hydraulic-brakes system; and air-conditioning system will cost about $40,000. Then, the trailer $40,000, and a stripped tractor $40,000 will cost together about $80,000.

To manufacture eighteen-wheeler semi-tractor and trailer according to this disclosure, with electric integrated propulsion and steering, may include in general: (i) stripped tractor and trailer $80,000; (ii) 10 propulsion electro-mechanical devices; eight 50 HP induction-motors $960 [@ $120] and two 100 HP induction motors $1,000 [@ $500]; (iii) Adding; 6 dog-clutch mechanisms [4 induction motors, two in the tractor and two in the trailer may be connected to the wheels at all times] $1,800; (iv) six steering electro-mechanical devices $3,000 [@ $500]; (v) 10 DC to DC converters $1,000 [@ $100]; 10 DC to AC inverters $1,000 [@ $100]; (vi) digital system-controller with all wiring at $4,000; (vii) 10 electric-brake systems $2,000 [@ $200] brakes won't be as powerful as in semi-trailers with diesel-engine since regenerative braking by 10 induction motors will do most of the job and evenly distributed along the tractor and trailer; and (viii) air-conditioning system $1,800; total without the battery-pack is about $97,000˜$100,000.

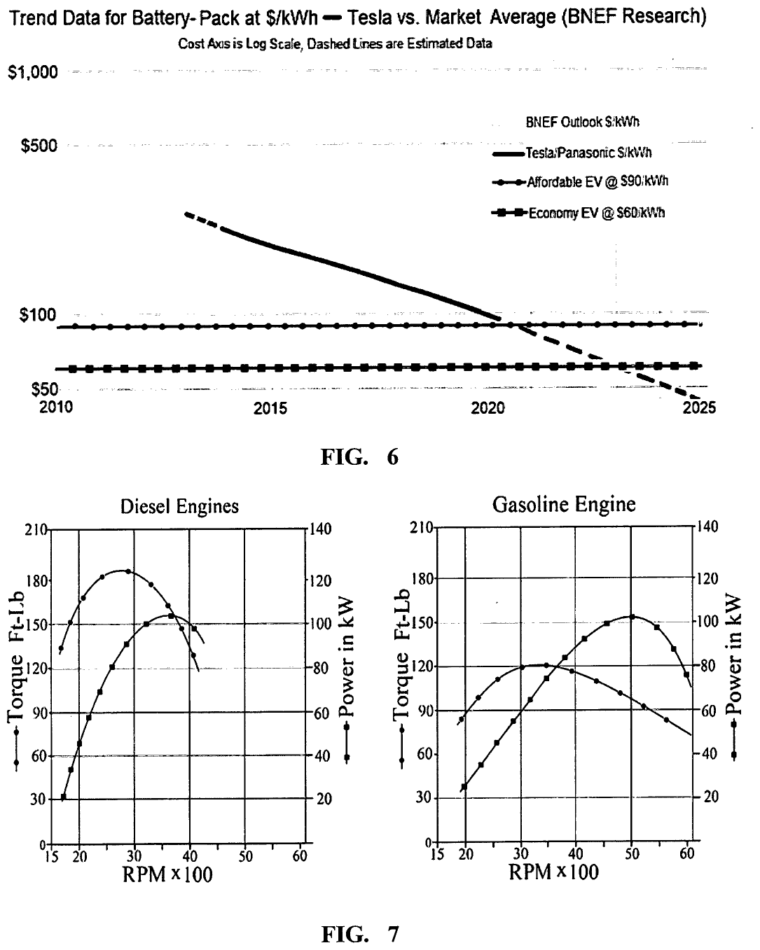

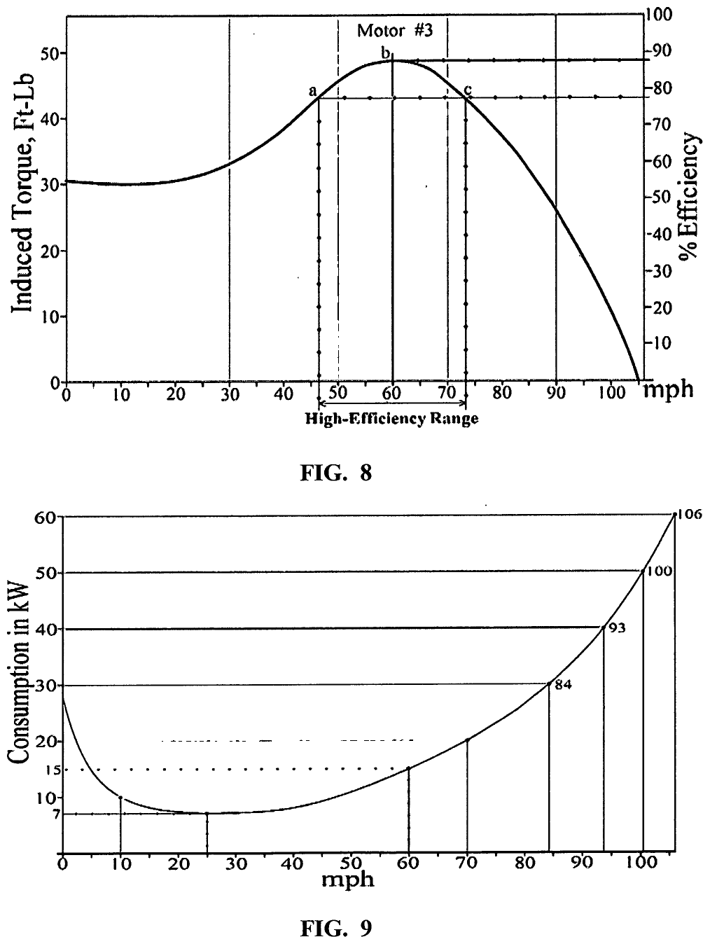

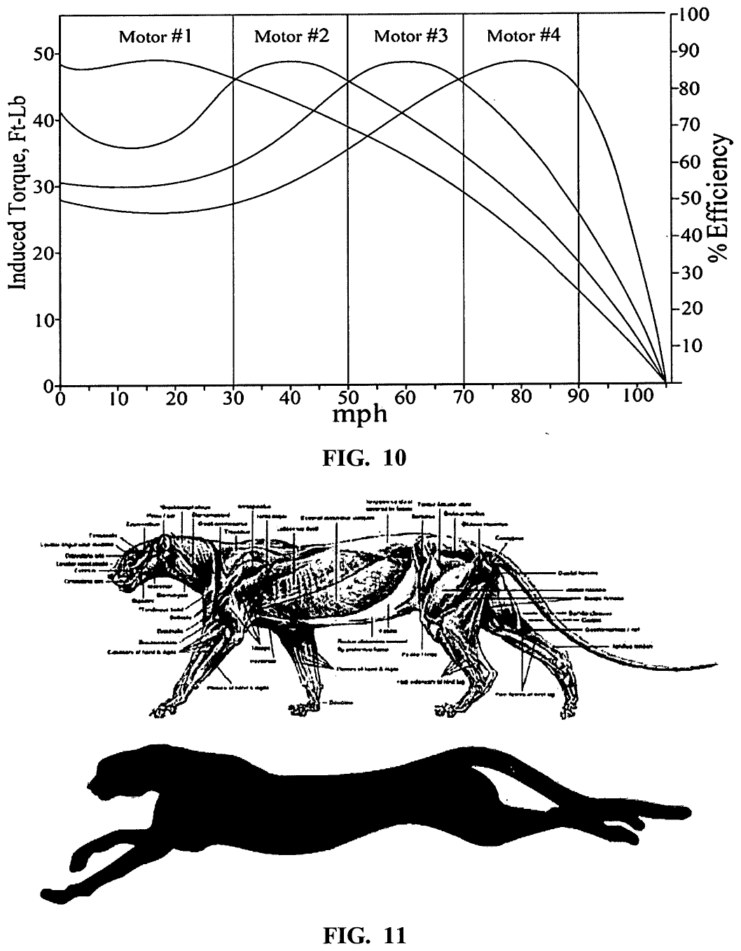

Under previous considerations in ¶ [0026] at 17 supra, the battery-pack weight and cost ¶ [0028] at 18 have a decisive role in designing electric buses, heavy-duty trucks and semi-trailers. Using Tesla semi's specifications, it was computed supra that for 480 Km range the battery-pack will cost $47,000 in today's $100/kWh price, and $23,500 when kWh price will reach $50/kWh in 2024 (see FIG. 6). For 960 Km range a battery-pack will cost $94,000 in today's price of $100/kWh, and $47,000 when kWh price reaches $50/kWh in 2024. However, the subject integrated propulsion & steering disclosure is claiming to have at least 25% better efficiency than Tesla's. Interpolating the subject disclosure's energy-pack as E_{P}=1.25 Km/kWh [Tesla's is about 1.02 Km/kWh] energy results to 480- and 960-Km range; then, equipped with the subject integrated propulsion and steering disclosure, loaded with maximum payload the semi-truck with 36,364 Kg, will consume 384 kWh, and 768 kWh respectively; and the battery-pack cost will be reduced to $38,400 and $76,800 with today's battery price of $100 kWh; and $19,200 to $38,400 when kWh price have reached $50 as depict in FIG. 6, respectively. The current price for a semi-trailer equipped with this disclosure is $138,400 and $176,800 in today's battery prices respectively; and further reduced to $119,200 and $138,400 respectively, which is much lower than semi-trailer with diesel engine.

Maintenance cost of a semi-trailer with this disclosure will be significantly lower than diesel semi-trailer. Average annual distance traveled by Class 8 diesel semi-trucks is about 75,000 miles; and the average efficiency is 6.5 miles per gallon, with yearly consumption of 75,000/6.5=11,540 gallons within a price of $3.90/gal, annual cost of fuel is about $45,000.

Semi-trailer with this disclosure and with the efficiency of 0.75 miles/kWh will consume 100,000 kWh to drive 75,000 miles; with $0.07/kWh commercial price of electricity=$7,000 and with 90% efficiency, annual ‘fuel’ cost=$7,700, which is $37,300 less than semi-truck with diesel engine. 3-years just fuel savings will buy a new electric semi-trailer. The additional expenses with diesel semi-trucks, such as tires replacement, engine lubrication and maintenance, are not available in e-semi-trailers because induction-motors are practically maintenance-free. The battery-pack replacement is only due after about 5-years, depending on the charging methods.

The Modular E-Drive Concept in this Disclosure

The modularity in assembling components of this disclosure is another advantageous aspect that could ease fitting this disclosure in any vehicle type.

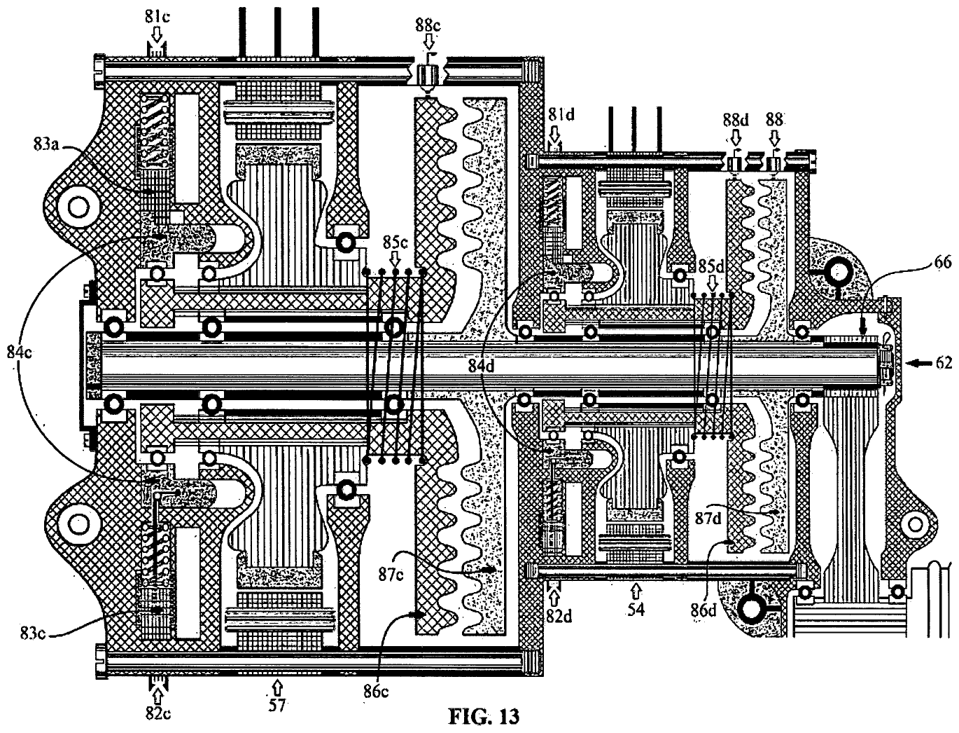

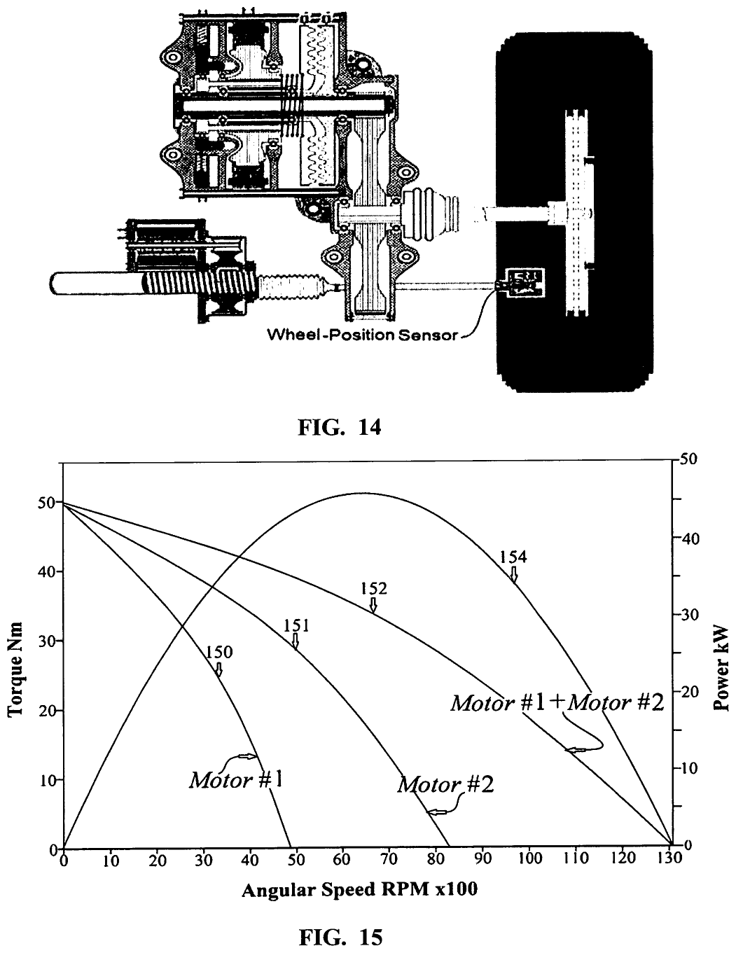

Attributable to Modularity of the Design, this disclosure further simplifies, and lowers manufacturing cost. FIGS. 12, 13, 14, 16, 28, 32, 33, 35 and 37 illustrates a design approach that subdivides systems into modules of various but similar electro-mechanical devices that may be manufactured in standardized size, yet designed with different ratings of power, torque, angular speed, and specific high efficiency range. Picking up the electro-mechanical devices in FIGS. 12 and 13 as standard manufacturing size of electro-mechanical propulsion devices for personal EVs; and electro-mechanical devices in FIGS. 13, 35 and 37 as standard manufacturing size of light- and heavy-duty trucks, buses and semi-trucks; then, infinite electro-mechanical devices' combinations of this disclosure's master system 10 as depict in FIG. 5 can be assembled in the same production line. Manufactured components with different specifications but with the same exact size—could share a standardized shaft 62 [as depict in FIGS. 12 and 13] and accommodate infinite embodiment. FIGS. 12 and 13 represent two different systems that are assembled with the same procedure, having the same function, yet carrying different specifications.

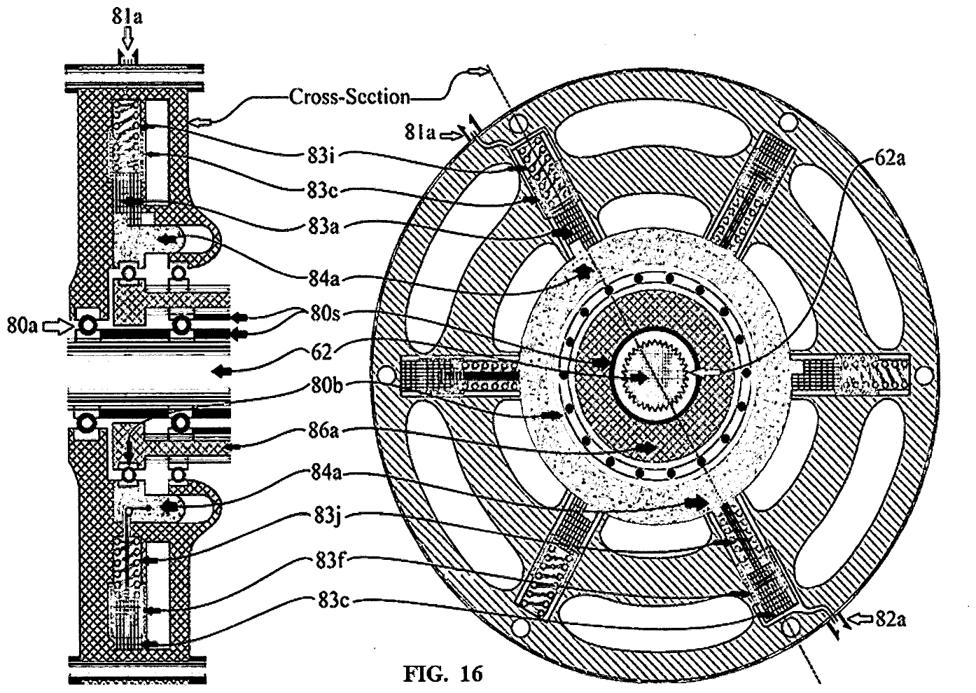

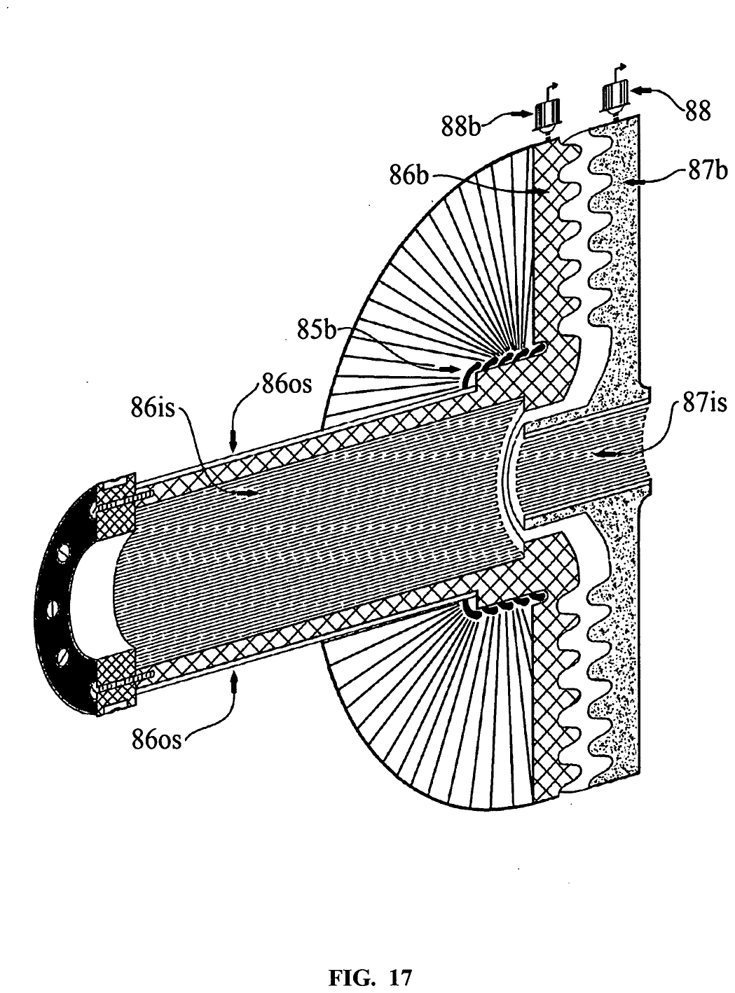

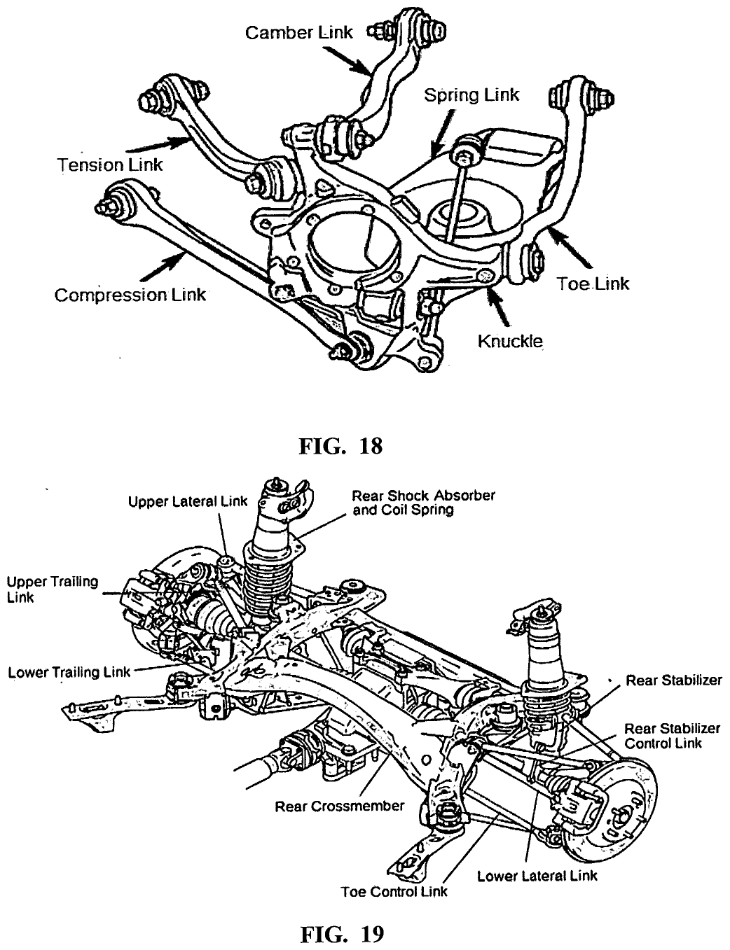

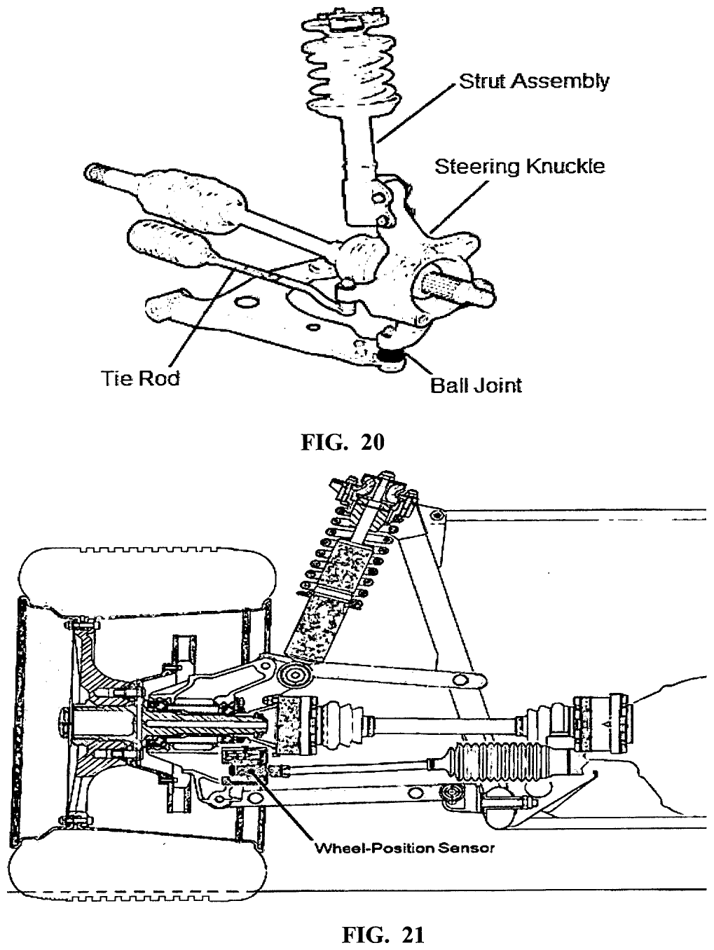

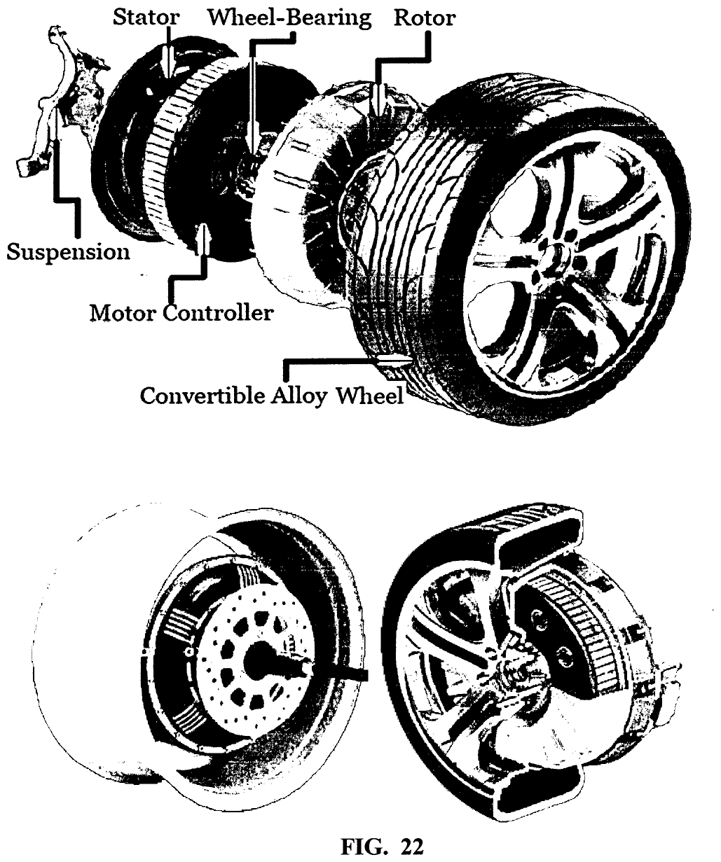

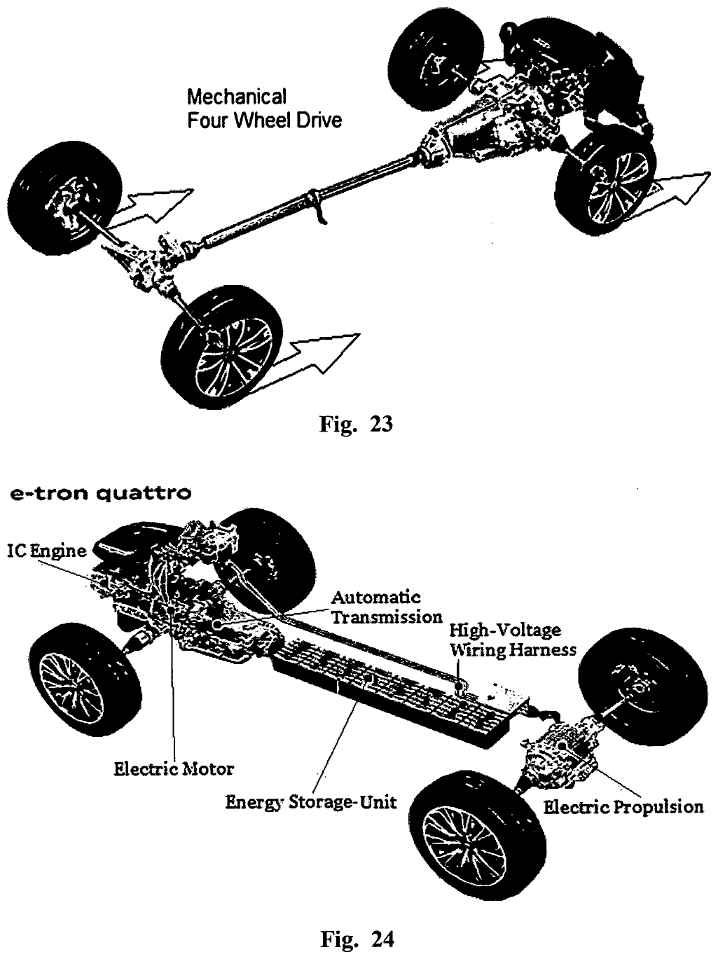

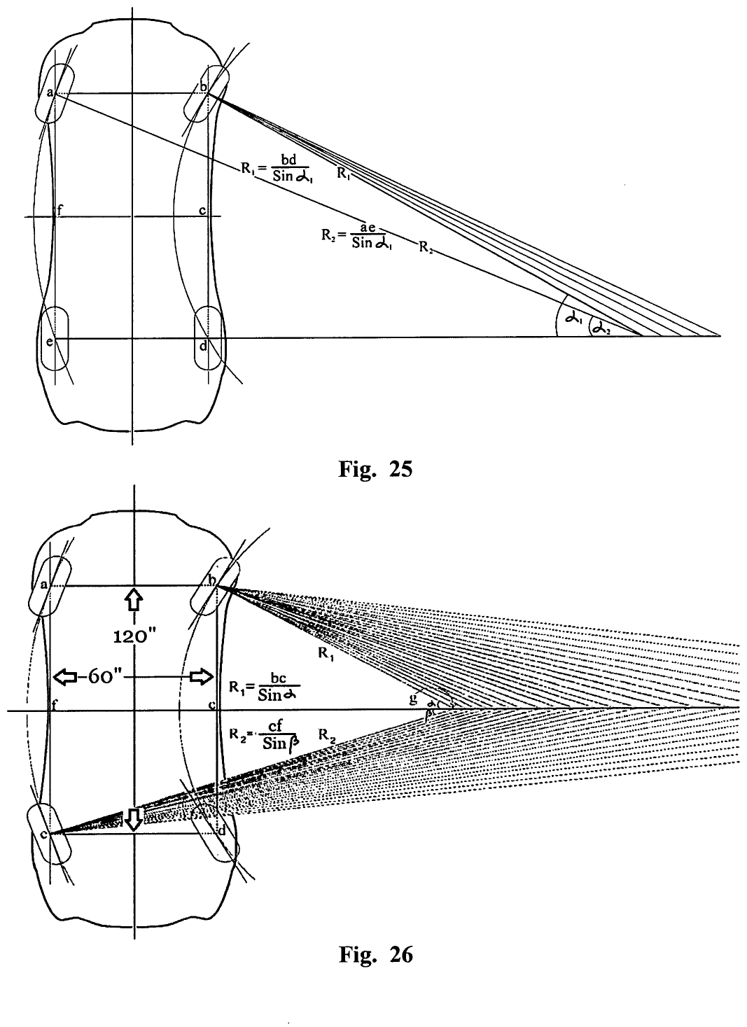

FIG. 16, 17 represent a cross-section of the aggregate that is responsible for coupling and decoupling dog-clutches within configuration of FIGS. 12 and 13. The six holes in the periphery of the circle in said aggregate may represent the location where six long bolts may be inserted to hold tight all the components as seen in FIGS. 12 and 13; e.g. the coupling and decoupling aggregates; the electric motors with their dog-clutch disks; and the opposing, permanently fixed—to the shared shaft—disks. All components are inserted by sliding them on the splines of the joint-shaft 62. Customization of power and torque in light duty and heavy-duty vehicles, is accomplished by first choosing the right length of joint-shaft 62, and then sliding-in additional electro-mechanical devices; or reducing the number of electro-mechanical devices; or replacing unwanted electro-mechanical devices; or replacing a defective one; the possibilities are endless.

It should be understood that in certain embodiment electronic controller may include conventional processing apparatus known in the art, and capable of executing pre-programmed instructions stored in associated memory, all performed in accordance with the functionality described herein. To the extent that the methods described herein are embodied in software, the resulting software may be stored in an associated memory where so described, may also constitute the means for performing such methods. Implementation of certain embodiment of the invention, where done so in software, would require no more than routine application of programming skills by one of ordinary skill in the art, in view of the foregoing enabling description. Such a controller be of the type having both ROM, RAM, a combination of non-volatile memory so that the software can be stored and yet allow storage and processing of dynamically produced data and/or signal

What is claimed is:

1. An electric propulsion system for a vehicle comprising:
a plurality of propulsion power sources coupled to a final drive of the vehicle propulsion system, are designed with different power rating, and different efficiency range of operation, wherein the plurality of propulsion power sources are overlapping each other's high efficiency range of operation to create a continuous, optimal efficient range of mobility from start through the maximum rated speed of the vehicle;
a plurality of propulsion power sources, as part of the propulsion system are coupled to, and decoupled from a final drive wherein electronic controlled dog-clutches are utilized;
an electronic dog-clutch systems within the vehicle propulsion system are configured to carry out coupling and decoupling of the plurality of propulsion power sources, wherein electronic, electro-magnetic and mechanical means are utilized;
a battery-pack with at least one energy storage-unit coupled to a DC bus via DC to DC converter;
a secondary energy storage units with numerous ultra-capacitor cells; and
a controller is programmed to:
determine a desired power demand from the plurality of power sources; elect the power sources to produce the desired power demand, wherein the controller actuates all or less than all of the plurality power sources comprise:
identifying, in a desired speed and load the most efficient power source from the plurality of power sources;
controlling the most efficient power source to produce the desired power at an optimum operating point of the identified power source;
identifying a power output of the most efficient power source corresponding to the optimum operating point;
comparing the power output of the most efficient power source to the desired power demand;
identifying a remaining power demand from the comparison; and
controlling another power source of the plurality of power sources to produce the remaining power demand.

2. The vehicle propulsion system of claim 1, may further comprising:
a fuel-cell energy producing unit coupled to propulsion power sources;
an internal combustion engine (IC engine) coupled to the final drive, and/or to a generator;
an electric propulsion power-sources comprising:
DC bus;
plurality of power sources coupled to a DC bus via DC to DC converter or DC to AC inverter;
a flywheels;
a photovoltaic cells; and
a combination of all or part of the modules listed in claim 2.

3. The vehicle propulsion system of claim 1, wherein a controller is programmed to split operation between all or less than all power sources, wherein multi-objective optimization algorithm is utilized to identify and control all or less than all propulsion power sources to satisfy the system power demand, wherein the least energy is consumed during all driving modes.

4. The vehicle propulsion system of claim 1, wherein the controller is further programmed to actuate all or less than all propulsion power sources to provide the torque and power, wherein the vehicle can manage to travel from zero to about 100 Km/h in such short time frame that will provide a safe vehicle maneuverability in any acceleration mode thereafter.

5. The vehicle propulsion system of claim 1, wherein a propulsion power sources, when actuated in the propulsion process, is coupled to another power source in series on a joint propulsion shaft, to combine the power-output as a single power source, wherein the controller may couple one or more propulsion power sources to the joint shaft to maintain low energy consumption while satisfying the vehicle power demand.

6. The vehicle propulsion system of claim 1, a few seconds after propulsion starts, wherein the vehicle gained sufficient kinetic energy, the controller is programmed to utilize multi-objective optimization algorithm to identify the propulsion's power demand; elects from the plurality of propulsion power sources the power source that is design to produce the anticipated power demand with the least consumption of energy, wherein the controller actuates the dog-clutch coupling mechanism to couple the identified power sources to the final drive.

7. The vehicle propulsion system of claim 2, a secondary energy storage unit with plurality of ultra-capacitor cells coupled to one another, where every single capacitor-cell may have a capacitance between 500 and 3000 Farads or greater; wherein the controller is configured to fit the ultra-capacitors into the propulsion start mode, wherein an ultra-capacitors can burst instantaneous power to complement the primary sources with batteries that suffers fast deterioration when repeatedly providing quick bursts of power in frequent start-stop vehicle applications, especially at lower temperatures.

8. The vehicle propulsion system of claim 1, in regenerative braking mode of operation, the controller is configured to couple all or less than all power sources to all wheels, including power sources that were not coupled at the time the breaking mode started; wherein the controller is configured to controls all bi-directional DC-DC converters to buck voltage of the respective DC bus and supply the bucked voltage to the respective energy storage units; wherein equal distribution of braking power is provided to all wheels for optimal stability, whilst wastage of the electric braking system is curtailed.

9. The electronic controlled dog-clutch of claim 1, wherein two dog-clutch disks are configured with dog-teeth, claws-teeth or any other means of concave indentation and convex projections that fits perfectly tight one inside the other when coupled; wherein the wheel-side disk is permanently fixed to the final drive and rotates whenever the vehicle is in motion, acting as flywheel when the disk is not coupled; wherein the power source disk is configured with a cylinder-like neck, having splines inside and outside the cylinder to facilitate the movement of the power source disk-clutch during the coupling and the decoupling of the dog-clutches.

10. The electronic controlled dog-clutch of claim 9, wherein the angular-speed of the wheel-side disk, and the angular-speed of the power source disk is constantly monitored by speed sensors, wherein the RPM information of each disk is transmitted with electronic means to the controller; whilst the elected power source to be coupled is not under load before coupling, wherein it enables the controller to actuate the power source and bring its revolutions to match precisely the angular speed of the wheel-side disk in a fraction of a second.

11. The electronic controlled dog-clutch of claim 9, wherein the feed-back mechanism between the speed sensor of the propulsion power source-disks and the controller, enables the controller to compute the proper voltage and modulation applied to the power source, wherein the propulsion power source disk RPM matches precisely the angular velocity of the wheel-side disk just before coupling, to secure an optimal coupling.

12. The electronic controlled dog-clutch of claim 9, wherein the controller is configured to actuate a set of solenoids comprising more than one electro-magnetic actuator to pull-back latches that lock the rear-ring of the power source's cylinder disk, which triggers the cylinder movement into coupling position; whilst the kinetic energy in a compressed spring between the power source's rotor and the back of the power source's disk is released to thrust the power source's disk forward on the splines molded inside and outside the disk cylinder, whilst the power source disk is rotating at precisely the same angular speed as the wheel-side disk under the controller's management, wherein the coupling with the wheel-side disk is carried out.

13. The electronic controlled dog-clutch of claim 12, wherein the controller elects to decouple a propulsion power source when said power source is no longer in its optimum efficiency load and speed range; the controller is configured to actuate a different than in claim 12 set of solenoids, which triggers the retraction of the propulsion power source disk cylinder's rear-ring with electro-magnetic means, whilst compressing the spring that kept the disk coupled, until the set of latches in claim 12 lock the rear-ring of the propulsion power sources disk's cylinder in secured decoupled position.

14. An electronic all-wheel steering system for a vehicle comprising:
an electronic steering-wheel sensor, coupled to the driver's steering-wheel shaft, wherein the driver's desired turning-angle, or the AV's [autonomous vehicle] Full Self Driving [FSD] computer elected turning angle information, is forwarded to the controller by enumerated electronic means;
a plurality of electro-mechanical wheel steering module comprising:
a plurality of electric power sources, fixed to the frame of the vehicle, wherein each electric power source converts rotational energy into linear movement, comprising:
a plurality of tie rods coupled in one side to the power source, the other side to a tie rod end, wherein each wheel is pushed or pulled to the left or the right side of the vehicle;
a plurality of tie rod ends connected to the knuckle's steering arm of each wheel carrying out two different tasks:
(I) as a tie rod end; and
(II) as wheel-position sensor, wherein a continuous information with electronic means is transmitted to the controller, providing the instantaneous position of each wheel in reference to strait forward;
a controller in claim 1 is configured inter alia, to execute control logic stored in its data base associated with all-wheel electronic steering, wherein the controller monitors information provided from the driver's steering-sensor, or the AV's FSD computer and from each individual wheel-position sensor;
the controller is further configured to utilize multi-objective optimization algorithm to compute in which angle each wheel has to be positioned to satisfy the driver's or the AV's FSD computer elected turning angle; and
the controller is configured to actuate all or less than all steering power sources, wherein a feedback mechanism between the controller and each wheel-position sensor provides the continuous monitoring of the changing-position of each wheel, whilst the wheel-position sensors are transmitting the electronic data to the controller, to continue the actuation of each steering power source until each wheel reaches the controller's computed angle;
the controller is further configured to identify from the plurality of propulsion power sources the power sources that will assist the steering process; wherein the controller is configured to compute the various power outputs and different velocities to be applied to the identified propulsion power sources that are elected to integrate in the steering process;

15. An electronic all-wheel steering system of claim 14, wherein a steering-wheel sensor is configured with multiple leaflets with electrical conductivity, representing the number of different angles or a fraction thereof the vehicle might take in turning modes; wherein each individual leaflet is connected by with electronic means directly to the controller, to individually transmit the driver's or the AV FSD computer elected turning-angle information.

16. An electronic all-wheel steering system of claim 14, wherein the electro-mechanical steering devices for the front and the rear of the vehicle may be configured differently for different type of vehicles, wherein a front electro-mechanical steering device may be configured with outer, powerful power source, for quick response, while a rear electro-mechanical steering device may be configured with an electro-mechanical rotor that is modified into rotating nut around a ball-screw, converting the rotor-nut electro-mechanical rotation into linear motion of the outer tie rods for better efficiency; yet, any power source may be utilized that can convert electrical-energy into liner movement of the tie rod to secure the wheel's movement to the controller's computed position.

17. An electronic all-wheel steering system of claim 16, wherein the electro-mechanical steering device's comprising a rotor configured as rotating nut around a ball-screw with bearing-balls captured between the nut and the screw-threads to minimize friction within the ball screw;

18. An electronic all-wheel steering system of claim 14, wherein the original tie rod end, in addition to its function as tie rod end, is also configured as wheel-position sensor comprising:
a pointer fixed to a shaft with a gear in the center of the wheel-position sensor, wherein a center gear is in tight contact with the teeth of a side-gear, wherein the side-gear teeth are in tight contact with teeth molded inside the wheel-position sensor housing;
a tie rod movement pushes the wheel knuckle-arm, wherein the wheel is pushed or pulled to the left or to the right, triggering a change in the angle between the tie rod and the wheel, directly proportional to the change in the wheel's position, wherein a movement of the wheel-position sensor housing molded teeth, rotates the side-gear, wherein the side-gear rotates the center-gear that forces the pointer to move to a specific point on the face of the wheel-position sensor, informing the controller by electronic means, the exact position of the wheel.

19. An electronic all-wheel steering system of claim 15, wherein a malfunction of one contact-leaflet in the steering-sensor or the wheel-position sensor; or in case of broken, disconnected or malfunctioning wire; the controller is programmed to utilize the last or the next contact reading, whilst reducing the velocity of the vehicle to a safe speed, to keep the affected wheel within safe range of less than 1° error, wherein a specific warning signal is turned-on to alert the driver or the AV's FSD compute of the malfunction's location; in case the entire wheel-position sensor is totally ‘out-of-order,’ the controller is configured to utilize the reading of the opposite side wheel-position sensor; interpolate the reading to compute the defective side wheel-position sensor reading, wherein to keep the vehicle in ‘fail safe system’ configuration while informing the driver or the AV's [FSD] compute of the malfunction.

20. An integration of all-wheel propulsion and steering system of claim 1 and claim 14, wherein the steering wheel sensor changed position, or the AV's [FSD] compute transmitted new steering information, the controller is configured to compute the angle of each wheel; activate each electro-mechanical steering device to bring each wheel to the computed angle; and actuates the left and the right propulsion power sources with different velocities after the controller computed the different distances the left and the right wheels have to travel at the same time frame; wherein integration of propulsion power sources in the steering process realizes a function of EPS [electric power-steering].

21. An all-wheel propulsion and steering system of claim 1 and claim 14, wherein the controller's dominance over each wheel power, speed and position; the controller is programmed with specific data, such as the vehicle center of gravity, and the threshold-point when the vehicle will overturn in any combination of turning angle and velocity; wherein in certain turning angels in unsafe velocity, the controller is configured to utilize multi-objective optimization algorithm and keep the speed below the threshold-point that will endanger the vehicle stability, yet afford the driver to make the turn safely in a reasonable speed to prevent the vehicle from turning-over.
